(19) United States
(12) Patent Application Publication
(10) Pub. No.: US 2005/0091372 A1
(43) Pub. Date: Apr. 28, 2005

(54) Data monitoring apparatus and network system equipped with such data monitoring apparatus, and also data monitoring method and computer program for performing such data monitoring method

(75) Inventor: Tsuyoshi Nagao, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 10/969,080

(22) Filed: Oct. 21, 2004

(30) Foreign Application Priority Data
Oct. 23, 2003 (JP) 2003-363481

(51) Int. Cl. G06F 15/173

(52) U.S. Cl. 709/224

(57) ABSTRACT

In the context of one or more shared servers equipped with one or more shared data storage units storing shared data shared by a plurality of users, a data monitoring apparatus for monitoring data stored by at least one of the shared data storage unit or units, the data monitoring apparatus comprising one or more evaluating units acquiring information pertaining to data stored by at least one of the shared data storage unit or units, carrying out one or more shareability evaluations of such data based on at least a portion of the information, and evaluating whether such data is involved in unauthorized use.

### CLAIM(S) IN CONNECTION WITH APPLICATION(S) AND/OR PRIORITY RIGHT(S)

This application claims priority under 35 USC 119(a) to Patent Application No. 2003-363481 filed in Japan on Oct. 23, 2003, the content of which is incorporated herein by reference in its entirety.

### BACKGROUND OF INVENTION

1. Field of Invention

The present invention relates to a data monitoring apparatus and a network system equipped with such data monitoring apparatus, and also to a data monitoring method and a computer program for performing such data monitoring method, for monitoring for unauthorized use of image processing apparatus(es) and/or presence of data involved in unauthorized use(s). In particular, in the context of system(s) equipped with shared server(s), the present invention pertains to strategies for monitoring with high accuracy whether data present on such shared server(s) is involved in unauthorized use.

2. Conventional Art

In recent years, it has become common in offices and so forth to construct systems in which personal computers and/or other such terminals are connected by way of networks to image processing apparatuses in digital hybrid devices and the like. Such image processing apparatuses typically take the form of hybrid devices serving as printers, scanners, copiers, and/or the like. That is, when functioning as a printer, print data (image data and/or text data) might be received from a terminal by way of a network; images, text, and/or the like being recorded onto recording paper based on such print data. When functioning as a scanner, a captured image of an original might be displayed at a terminal display or the like. When functioning as a copier, an image of an original captured by means of the foregoing scanner function might be recorded onto recording paper.

As examples of publications disclosing such systems, Japanese Patent Application Publication Kokai No. 2002-116901 (hereinafter “Patent Reference No. 1”), Japanese Patent Application Publication Kokai No. 2000-330847 (hereinafter “Patent Reference No. 2”), and Japanese Patent Application Publication Kokai No. 2002-236809 (hereinafter “Patent Reference No. 3”) may be cited. These Patent References disclose systems in which networks are constructed from shared servers storing data shared by users, and terminals belonging to the respective users.

While network systems equipped with image processing apparatuses as have been described above greatly contribute to improvement in efficiency of office operations, because image processing apparatuses can be simply and conveniently used, unauthorized use for personal (private) rather than business purposes has not been an infrequent occurrence.

Patent Reference No. 1 was conceived with the intention of inhibiting such unauthorized use of image processing apparatuses. More specifically, when carrying out recording (printing) of data onto recording paper, by storing the recorded data and an ID number of the user requesting recording of this data in mutually associated fashion it is possible for an administrator to know which users are recording what data, making it possible to ascertain whether unauthorized use of an image processing apparatus is occurring. Furthermore, at this Patent Reference No. 1, whether to store information associating an ID number of a user with image data that has been recorded is determined based on save rates previously established for each user.

However, with the art disclosed at the foregoing Patent Reference No. 1, while save rates are previously established for each user and some consideration is made for storage of data for which there is a high probability of occurrence of unauthorized use, the effectiveness of this has nonetheless been inadequate and there has been need for further improvement. Reasons why such further improvement is necessary are given below.

In accordance with the art disclosed at this Patent Reference No. 1, it being previously established that documents at shared servers, being shared documents, are not involved in unauthorized use, an unconditional determination is made such that in the event that there is an instruction to print a document present on such a shared server, this is not considered to be an unauthorized use. In other words, the data printed as a result of this print instruction and the ID number of the user issuing the instruction are not stored. Accordingly, in the event that documents intended for personal use (documents involved in unauthorized use) are placed on a shared server, notwithstanding that there might be occurrence of unauthorized use in which such documents intended for personal use are printed, monitoring of same would be precluded and the unauthorized use would be allowed to occur.

But when documents intended for personal use are placed on a shared server in such fashion, if the documents placed on the shared server are visible to a large number of users this might serve to inhibit unauthorized use even when no special monitoring is carried out. However, when, as at the foregoing Patent Reference No. 2, it is an easy matter to alter the list of users permitted to share a particular document, it is possible that abuse will occur in which documents intended for personal use are concealed from other users. Furthermore, while Patent Reference No. 3 proposes prohibiting deletion of documents declared to be in use, the technical idea here is not to prohibit deletion operations designed to reduce the time when a document intended for personal use is made visible to others by immediately deleting the document following placement of the document on a shared server and printing of same; which is to say that the technical idea here is not to prohibit unauthorized use.

### SUMMARY OF INVENTION

The present invention was conceived in light of the such points, it being an object thereof to utilize data attribute information and/or the like pertaining to data present on shared server(s) and/or printing of data (image data and/or text data) on such shared server(s) to extract, with high success rate(s), data for which there is/are high probability or probabilities of occurrence of unauthorized use, reduce monitoring burden(s) assumed by administrator(s), and achieve improved efficiency in monitoring procedures.

A data monitoring apparatus in accordance with one or more embodiments of the present invention, in the context of one or more shared servers equipped with one or more shared data storage units storing shared data shared by a plurality of users, is a data monitoring apparatus for monitoring data stored by at least one of the shared data storage unit or units, the data monitoring apparatus comprising one or more evaluating units acquiring information pertaining to data stored by at least one of the shared data storage unit or units, carrying out one or more shareability evaluations of such data based on at least a portion of the information, and evaluating whether such data is involved in unauthorized use.

As examples of what is here referred to as “information pertaining to data,” while the number of users capable of accessing such data, file extension(s) of file(s) containing data, file format(s) assigned to file extension(s) of file(s) containing data, actual file format(s) of data, file attribute(s) of data (hidden attribute(s) determining access permission(s) and/or the like), whether such data is present on shared server(s), and/or the like may be cited, the present invention is not limited hereto.

As a result of evaluative operation(s) carried out by the evaluating unit(s), such data monitoring apparatus(es) in accordance with embodiment(s) of the present invention make it possible, when data intended for personal use is present on the shared server(s), to find such data (data involved in unauthorized use) based on information pertaining to such data. Whereas in the conventional art, determination as to unauthorized use was not carried out for data on shared servers, data on shared servers being unconditionally determined to be shareable; such data monitoring apparatus(es) in accordance with embodiment(s) of the present invention permit definitive inhibition of unauthorized use involving misuse of shared server(s).

Alternatively or in addition thereto, a data monitoring apparatus in accordance with one or more embodiments of the present invention, in the context of one or more network systems equipped with one or more shared servers storing shared image data shared by a plurality of users and equipped with one or more image processing apparatuses connected by network to at least one of the shared server or servers and performing image processing on image data acquired from at least one of the shared server or servers, is a data monitoring apparatus for monitoring image data handled by at least one of the image processing apparatus or apparatuses, the data monitoring apparatus comprising one or more identifying units identifying one or more users requesting image processing; one or more storage units capable of storing information linking at least one of the user or users identified by at least one of the identifying unit or units and at least a portion of image data involved with image processing requested by at least one of the identified user or users; and one or more determining units determining whether to store information in at least one of the storage unit or units; wherein at least one of the determining unit or units has one or more evaluating units acquiring, by accessing at least one of the shared server or servers, information pertaining to source data for image data handled by at least one of the image processing apparatus or apparatuses, and evaluating whether at least a portion of the source data is involved in unauthorized use; wherein, only in the event that it is determined based on at least one result of such evaluation that image data is involved in unauthorized use, is information linking at least a portion of such image data and at least one of the user or users requesting image processing of such image data caused to be stored by at least one of the storage unit or units.

Furthermore, in a data monitoring apparatus in accordance with one or more embodiments of the present invention, at least one of the identifying unit or units, at least one of the storage unit or units, and at least one of the determining unit or units may be provided at at least one of the image processing apparatus or apparatuses.

In accordance with such data monitoring apparatus(es) according to embodiment(s) of the present invention, where image data involved in unauthorized use is processed, it is possible, in the context of an arrangement in which monitoring of unauthorized use takes place by causing information linking at least a portion of such image data and user(s) requesting image processing of such image data to be stored in at least one of the storage unit or units, to, when performing image processing on image data acquired from at least one of the shared server or servers, extract, with high success rate(s), only image data involved in unauthorized use and cause same to be stored in at least one of the storage unit or units. This being the case, it is possible for administrator(s) to monitor unauthorized use without the need to examine large quantities of data. As a result, it is possible to achieve reduction in required storage capacity or capacities of the storage unit(s), reduction in monitoring burden(s) assumed by administrator(s), and improved efficiency in monitoring procedures.

Furthermore, also within the purview of the technical idea of the present invention are network systems wherein at least one image processing apparatus or apparatuses equipped with at least one such data monitoring apparatus is connected by network to at least one of the shared server or servers; and image processing of image data acquired from at least one of the shared server or servers is carried out by at least one of the image processing apparatus or apparatuses.

In accordance with such network system(s) according to embodiment(s) of the present invention, it is possible for referencing and manipulation of data on the shared server(s) to be carried out via network from the data monitoring apparatus(es), and it is possible for storage and acquisition of information on the data monitoring apparatus(es) to be carried out via network from the shared server(s). Moreover, because interface(s) is/are made public in network fashion, development of network program(s) capable of accessing public interface(s) of the shared server(s) is made possible.

Alternatively or in addition thereto, a data monitoring apparatus in accordance with one or more embodiments of the present invention is a data monitoring apparatus for monitoring image data within one or more shared servers storing shared image data shared by a plurality of users, the data monitoring apparatus comprising one or more evaluating units acquiring information pertaining to image data subject to monitoring, and evaluating whether such image data is involved in unauthorized use; wherein, only in the event that it is determined based on at least one result of such evaluation that image data is involved in unauthorized use, is information to that effect sent.

Furthermore, in a data monitoring apparatus in accordance with one or more embodiments of the present invention, at least one of the evaluating unit or units may be provided at at least one of the shared server or servers.

Furthermore, a data monitoring apparatus in accordance with one or more embodiments of the present invention may comprise one or more identifying units identifying one or more users requesting image processing; one or more storage units capable of storing information linking at least one of the user or users identified by at least one of the identifying unit or units and at least a portion of image data involved with image processing requested by at least one of the identified user or users; and one or more determining units determining whether to store information in at least one of the storage unit or units; wherein at least one of the identifying unit or units, at least one of the storage unit or units, and at least one of the determining unit or units are provided at at least one image processing apparatus connected by network to at least one of the shared server or servers; and only in the event that information to the effect that determination has been made that image data is involved in unauthorized use is received from at least one of the shared server or servers, does at least one of the determining unit or units cause information linking at least a portion of such image data and at least one of the user or users requesting image processing of such image data to be stored by at least one of the storage unit or units.

Furthermore, also within the purview of the technical idea of the present invention are network systems wherein at least one of the shared server or servers equipped with at least one of the evaluating unit or units of at least one such data monitoring apparatus is connected by network to at least one of the image processing apparatus or apparatuses; and image processing of image data acquired from at least one of the shared server or servers is carried out by at least one of the image processing apparatus or apparatuses.

In accordance with such data monitoring apparatus(es) and/or network system(s) according to embodiment(s) of the present invention, it is possible to monitor at the shared server(s) itself or themselves whether data intended for personal use is present within image data stored at such shared server(s). That is, even where processing (printing processing or the like) of image data stored at the shared server(s) is not performed, it is possible to find data involved in such unauthorized use. Furthermore, in the event that image data involved in unauthorized use is processed, it is possible, where information linking at least a portion of such image data and user(s) requesting image processing of such image data is caused to be stored in the storage unit(s), to easily identify image data involved in unauthorized use as well as user(s) requesting image processing of such image data, permitting further reduction in monitoring burden(s) assumed by administrator(s).

Note that while configurations have been described in which at least one of the evaluating unit or units is provided at at least one of the shared server or servers, and/or wherein at least one of the identifying unit or units, at least one of the storage unit or units, and at least one of the determining unit or units are provided at at least one of the image processing apparatus or apparatuses, the present invention is not limited to such configurations. For example, also within the purview of the technical idea of the present invention are configurations in which one or more species selected from among the group consisting of at least one of the identifying unit or units, at least one of the storage unit or units, and at least one of the determining unit or units is or are provided at at least one of the shared server or servers.

Alternatively or in addition thereto, a data monitoring apparatus in accordance with one or more embodiments of the present invention, in the context of one or more network systems in which one or more shared servers storing shared image data shared by a plurality of users, one or more image processing apparatuses performing image processing on image data acquired from at least one of the shared server or servers, and one or more monitoring servers are connected by network, is a data monitoring apparatus for monitoring image data handled by at least one of the image processing apparatus or apparatuses, the data monitoring apparatus comprising one or more identifying units identifying one or more users requesting image processing; one or more storage units provided at at least one of the monitoring server or servers and capable of storing information linking at least one of the user or users identified by at least one of the identifying unit or units and at least a portion of image data involved with image processing requested by at least one of the identified user or users; and one or more determining units determining whether to store information in at least one of the storage unit or units; wherein at least one of the determining unit or units has one or more evaluating units acquiring, by accessing at least one of the shared server or servers, information pertaining to source data for image data handled by at least one of the image processing apparatus or apparatuses, and evaluating whether at least a portion of the source data is involved in unauthorized use; wherein, only in the event that it is determined based on at least one result of such evaluation that image data is involved in unauthorized use, is information linking at least a portion of such image data and at least one of the user or users requesting image processing of such image data caused to be stored by at least one of the storage unit or units.

Furthermore, also within the purview of the technical idea of the present invention are network systems wherein at least one of the monitoring server or servers equipped with at least one of the storage unit or units of at least one such data monitoring apparatus is connected by network to at least one of the shared server or servers and to at least one of the image processing apparatus or apparatuses; and image processing of image data acquired from at least one of the shared server or servers is carried out by at least one of the image processing apparatus or apparatuses.

Such data monitoring apparatus(es) and/or network system(s) according to embodiment(s) of the present invention is or are effective, for example, when constructing network(s) from the shared server(s), a plurality of the image processing apparatuses, and the monitoring server(s). That is, this would make it possible for administrator(s) to carry out administration in batch fashion with regard to unauthorized use carried out at the respective image processing apparatuses by utilizing information stored at the storage unit(s) at the monitoring server(s) to determine whether there is unauthorized use.

Note that for the purpose of such batch administration it is sufficient that at least one of the storage unit or units be provided at at least one of the monitoring server or servers, it being within the purview of the technical idea of the present invention regardless of whether at least one of the identifying unit or units and/or at least one of the determining unit or units (including at least one of the evaluating unit or units) is or are provided at at least one of the monitoring server or servers, at least one of the shared server or servers, and/or at least one of the image processing apparatus or apparatuses.

Furthermore, in a data monitoring apparatus in accordance with one or more embodiments of the present invention, at least one of the identifying unit or units may identify at least one ID number of at least one of the user or users requesting image processing.

Furthermore, in a data monitoring apparatus in accordance with one or more embodiments of the present invention, at least one of the evaluating unit or units may compare one or more numbers of user(s) capable of accessing data subject to evaluation and one or more previously established default number(s) of share(s); and in the event that at least one of the number(s) of user(s) capable of access is less than at least one of the default number(s) of share(s), may cause such data to be evaluated as being involved in unauthorized use.

This is in response to the fact that there is a high probability that permission(s) and/or other setting(s) for data intended for personal use will be set so as to permit access by only one or a very small number of users, and so evaluative operation(s) may be such that data having such setting(s) is determined to be involved in unauthorized use. Furthermore, what is here referred to as “number(s) of user(s) capable of access” may be determined from the number(s) of person(s) remaining upon elimination of redundant entries after extracting the individual(s) capable of accessing (i.e., at least having permission to read) the file(s) containing such data, from the individual(s) and/or the group(s) listed under permission(s) and/or other setting(s) for the file(s) and from group data listing the individual(s) set as member(s) of each group.

Furthermore, a data monitoring apparatus in accordance with one or more embodiments of the present invention may be such that, in the event that one or more files containing data subject to evaluation has or have no file extension, at least one of the evaluating unit or units causes such data to be evaluated as being involved in unauthorized use.

This is in response to the fact that there is a possibility that file extension(s) of data intended for personal use will be deliberately deleted, and so evaluative operation(s) may be such that data for which file extension(s) have been deleted in such fashion, being determined not to be ordinary shared data, is determined to be involved in unauthorized use.

Furthermore, a data monitoring apparatus in accordance with one or more embodiments of the present invention may be such that, in the event that at least one file extension of at least one file containing data subject to evaluation does not correspond to one or more established file formats previously assigned to each respective variety of file extension, at least one of the evaluating unit or units causes such data to be evaluated as being involved in unauthorized use.

This is in response to the fact that there is a possibility that file extension(s) of data intended for personal use will be deliberately altered, and so evaluative operation(s) may be such that data for which file extension(s) have been altered in such fashion, being determined not to be ordinary shared data, is determined to be involved in unauthorized use.

Furthermore, a data monitoring apparatus in accordance with one or more embodiments of the present invention may be such that it further comprises one or more actual format detecting units detecting one or more actual file formats of data subject to evaluation; wherein at least one of the evaluating unit or units receives one or more output signals from at least one of the actual format detecting unit or units, and in the event that at least one file format assigned to at least one file extension of at least one file containing data subject to evaluation does not match at least one of the actual file format, causes such data to be evaluated as being involved in unauthorized use.

This is in response to the fact that there is a possibility that file format(s) of data intended for personal use will be deliberately altered, and so evaluative operation(s) may be such that data for which file format(s) have been altered in such fashion such that file format(s) is/are set so as to be other than actual file format(s), being determined not to be ordinary shared data, is determined to be involved in unauthorized use.

Furthermore, a data monitoring apparatus in accordance with one or more embodiments of the present invention may be such that at least one of the evaluating unit or units compares one or more file attributes of data subject to evaluation and one or more default file attributes previously established for such data; and in the event that at least one of the file attribute or attributes of data subject to evaluation does not match at least one of the default file attribute or attributes, causes such data to be evaluated as being involved in unauthorized use.

This is in response to the fact that there is a possibility that file attribute(s) of data intended for personal use will be deliberately altered (e.g., setting(s) could be changed to that or those of hidden file(s)), and so evaluative operation(s) may be such that data for which file attribute(s) have been altered in such fashion, being determined not to be ordinary shared data, is determined to be involved in unauthorized use. Furthermore, what is here referred to as “alteration of file attribute(s)” includes not only situations in which group(s) and/or individual(s) capable of access have been deleted and/or altered, but also includes situations in which setting(s) are changed to that or those of hidden file(s) and/or system file(s) so as to cause icon(s) or the like not to be displayed.

Furthermore, a data monitoring apparatus in accordance with one or more embodiments of the present invention may be such that, in the event that data subject to evaluation is no longer present on at least one of the shared server or servers, at least one of the evaluating unit or units causes such data to be evaluated as being involved in unauthorized use.

This is in response to the fact that there is a possibility that data intended for personal use will be subject to manipulation to remove it from the purview of monitoring, e.g., by deleting same from shared server(s) immediately following printing thereof, and so evaluative operation(s) may be such that data thus no longer present on shared server(s) (due to deletion thereof by user(s)), being determined not to be ordinary shared data, is determined to be involved in unauthorized use.

Furthermore, a data monitoring apparatus in accordance with one or more embodiments of the present invention may be such that a plurality of the evaluative operations described above are employed in combination by at least one of the evaluating unit or units on data subject to evaluation so as to evaluate whether such data is involved in unauthorized use.

While examples may be cited such as that in which data is evaluated as being involved in unauthorized use unless such data is evaluated as being not involved in unauthorized use at all evaluative operations, the present invention is not limited to such evaluation.

Such data monitoring apparatus(es) in embodiment(s) of the present invention make it possible to carry out shareability evaluation(s) with high reliability on data stored at the shared server(s), and make it possible to monitor with high accuracy whether data present on the shared server(s) is involved in unauthorized use.

Alternatively or in addition thereto, a data monitoring method in accordance with one or more embodiments of the present invention is capable of being carried out by any of the foregoing data monitoring apparatuses, the data monitoring method comprising one or more information acquiring steps in which information pertaining to data stored by at least one of the shared data storage unit or units of at least one of the shared server or servers is acquired; and one or more evaluative steps in which one or more shareability evaluations of such data is or are carried out based on at least a portion of the information acquired at at least one of the information acquiring step or steps, and evaluation is made with respect to whether such data is involved in unauthorized use.

Alternatively or in addition thereto, also within the purview of the technical idea of the present invention is a computer program for causing one or more computers to carry out one or more of such data monitoring methods, the program causing execution of one or more information acquiring steps in which information pertaining to data stored by at least one of the shared data storage unit or units of at least one of the shared server or servers is or are caused to be acquired by at least one of the data monitoring apparatus or apparatuses; and one or more evaluative steps in which one or more shareability evaluations of such data is or are caused to be carried out based on at least a portion of the information acquired at at least one of the information acquiring step or steps, as a result of which evaluation is made with respect to whether data is involved in unauthorized use.

### BRIEF DESCRIPTION OF DRAWINGS

FIG. 1 is a block diagram showing the constitution of a network system associated with a first embodiment (drawn in two sections at FIG. 1(a) and FIG. 1(b)).

FIG. 2 is a flowchart showing copying processing operations.

FIG. 3 is a flowchart showing printing processing operations.

FIG. 4 is a flowchart showing operations in accordance with Shared Document Determining Algorithm 1.

FIG. 5 is a drawing showing a table containing default setting for number of shares.

FIG. 6 is a flowchart showing operations in accordance with Shared Document Determining Algorithm 2.

FIG. 7 is a drawing showing a table indicating correspondence between file extension and file format.

FIG. 8 is a flowchart showing operations in accordance with Shared Document Determining Algorithm 3.

FIG. 9 is a drawing showing an example of document data.

FIG. 10 is a drawing showing a table containing default access permission settings.

FIG. 11 is a flowchart showing operations in accordance with Shared Document Determining Algorithm 4.

FIG. 12 is a flowchart of Shared Document Determining Algorithm a, this being an example of combined use of n shared document determining subalgorithms.

FIG. 13 is a flowchart of Shared Document Determining Algorithm β, this being another example of combined use of n shared document determining subalgorithms.

FIG. 14 is a flowchart of Comprehensive Determining Algorithm 3.

FIG. 15 shows a table containing weights applied to respective shared document determining subalgorithms, these being referred to at the flowchart of FIG. 14.

FIG. 16 is a drawing showing a basic save rate table.

FIG. 17 is a drawing showing a user data table.

FIG. 18 is a block diagram showing the constitution of a network system associated with a second embodiment (drawn in two sections at FIG. 18(a) and FIG. 18(b)).

### DESCRIPTION OF PREFERRED EMBODIMENTS

Below, embodiments of the present invention are described with reference to the drawings.

### Embodiment 1

A first embodiment of the present invention will now be described. Description of the present embodiment is carried out in terms of an example in which the present invention is applied to a network system in which a plurality of user terminals (information processing apparatuses), one digital copier (image processing apparatus), and one shared server are connected by LAN (Local Area Network).

1. Description of Network System 100 Constitution

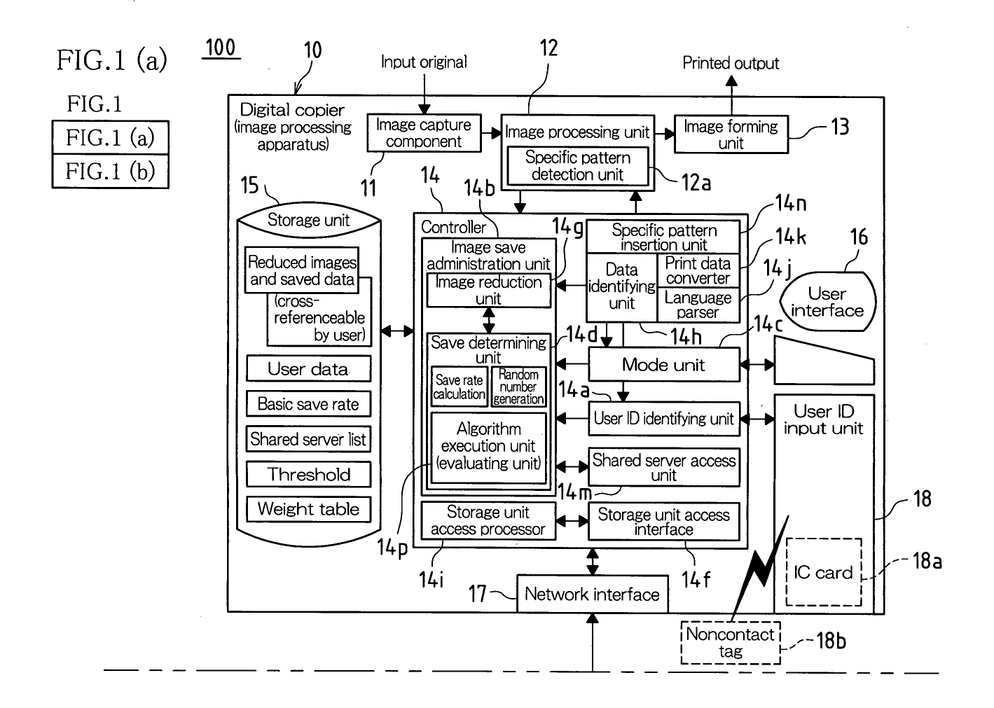

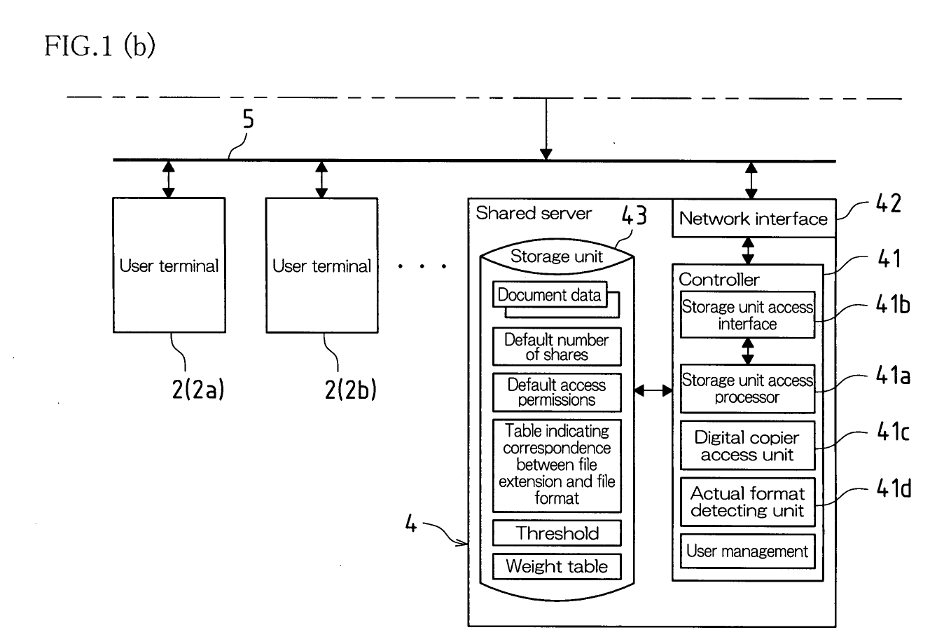

FIG. 1 is a block diagram showing network system 100 which is equipped with data monitoring apparatus(es) associated with the present embodiment. This network system 100 shown in FIG. 1, which might be used in an office or the like, is constructed by using network cable(s) 5 to mutually connect shared server(s) 4, a plurality of user terminals 2 comprising workstation(s) and/or personal computer(s), image processing apparatus(es) (digital copier(s)) 10 serving as scanner(s), printer(s), and/or copier(s) (which may hereinafter be referred to as “copy machine(s)”), and so forth. In the description that follows, note that where necessary to distinguish between individual user terminals 2 lowercase letters will be appended to the reference number after the fashion of “2a” and “2b”.

Image processing apparatus 10 is constituted so as to function as copy machine to record image(s) of captured original(s) onto paper; so as to function as printer to record image(s) based on image data received from respective user terminal(s) 2 onto paper; and so as to function as scanner to send captured original image data to respective user terminal(s) 2.

When image processing apparatus 10 is used as copy machine, original(s) is/are placed in or on image capture component(s) 11, instruction(s) to copy original(s) being given by means of input operation(s) carried out at user interface(s) 16. In response thereto, controller(s) 14 cause image capture component(s) 11 to commence operation(s) in order to copy image(s) of original(s). Image capture component 11 captures image(s) of original(s), and outputs image data generated based on such image(s) to image processing unit(s) 12. At image forming unit(s) 13, image(s) based on this image data is/are recorded onto recording paper, and this recording paper is discharged.

The present image processing apparatus 10 might be capable of producing monochromatic images and/or color images. When copying image(s) of original(s) onto recording paper, instruction(s) as to selection of whether to produce monochromatic image(s) and/or color image(s) might be made by means of operation(s) carried out at user interface(s) 16 together with the instruction(s) to carry out copying. In the event that there is an instruction to carry out color copying, image data representing color image(s) is output from image capture component 11, this image data is processed at image processing unit 12, and color image(s) is/are recorded onto recording paper at image forming unit 13. Conversely, in the event that there is an instruction to produce monochromatic image(s), image data representing monochromatic image(s) is output from image capture component 11, this image data is processed at image processing unit 12, and monochromatic image(s) is/are recorded onto recording paper at image forming unit 13.

Furthermore, when image processing apparatus 10 is used as printer, image data representing images, text, and/or the like might, for example, be sent to image processing apparatus 10 by way of network cable 5 from first user terminal 2a. Image processing apparatus 10 receives print data at network interface(s) 17, and language parsing of print data is carried out by language parser 14j provided at controller 14 and conversion of print data is carried out at print data converter 14k based on results of this language parsing; and after various types of image processing have been carried out, image(s) are recorded onto recording paper by image forming unit(s) 13.

Alternatively or in addition thereto, an instruction to the effect that one set of image data is to be recorded might come from second user terminal 2b to shared server(s) 4 via network cable(s) 5, in which case controller(s) 41 of shared server(s) 4 might receive such instruction by way of network interface(s) 42 and might cause operations to commence at storage unit access processor(s) 41a. Storage unit access processor(s) 41a searches storage unit(s) 43 for such image data, sending this image data, when found, to image processing apparatus(es) 10 via network cable(s) 5. Image processing apparatus 10 receives such image data at network interface 17, and inputs this image data to image processing unit 12 by way of controller 14. After being processed by image processing unit 12, this image data is input at image forming unit 13. At image forming unit 13, image(s) represented by this image data is/are recorded onto recording paper.

When thus functioning as printer as well, it might be possible to record monochromatic image(s) and/or color image(s), instruction(s) as to whether image(s) should be monochromatic and/or color being received by image processing apparatus(es) 10 from respective user terminal(s) 2 and/or shared server(s) 4.

Furthermore, when image processing apparatus 10 is used as scanner, original(s) is/are placed in or on image capture component(s) 11, instruction(s) to capture image(s) of original(s) being given by means of input operation(s) carried out at user interface(s) 16. Image capture component 11 captures image(s) of original(s); image data based on such image(s) is subjected to image processing performed by controller 14 so as to cause this image data to be in format(s) recognizable by, for example, first user terminal 2a; and this image data is sent to first user terminal 2a via network cable 5. First user terminal 2a uses preview program(s) to cause this image data to be displayed at display apparatus(es) (display(s)) serving as user interface(s).

Furthermore, image processing apparatus 10 may be provided with storage unit access processor(s) 14i and storage unit access interface(s) 14f permitting access via network(s). Storage unit access processor(s) 14i process processing request(s) arriving at storage unit access interface(s) 14f. Storage unit access interface(s) 14f is/are interface permitting access to various types of information pertaining to image processing apparatus(es) 10. For example, this might be an interface permitting access to such items as user IDs and image data linked thereto, IP addresses of image processing apparatuses, shared server lists, and basic save rates, described below; permitting update of settings; and/or permitting viewing of user IDs involved in unauthorized use and images linked to such user IDs.

This being the case, network program(s) and/or administrator(s) at image processing apparatus 10 will be able to access various information pertaining to image processing apparatus 10 via network and will be able to carry out various administrative tasks and/or monitoring tasks.

For example, if an administrator at image processing apparatus 10 wanted to change basic save rates listed in basic save rate table 14e shown in FIG. 16, an administrator at image processing apparatus 10 might use a web browser or the like to access image processing apparatus 10 and open a basic save rate settings page. For example, a URL for a basic save rate settings page might take the form “http://<IP address of image processing apparatus>”, it being possible to open the URL of the basic save rate settings page by clicking on that link. Next, desired value(s) would be entered at that page. Furthermore, basic save rates could be updated by carrying out update operation(s). Update processing might be carried out at storage unit access processor 14i. HTTP's POST method might ordinarily be used for update operations.

Such operations could additionally or alternatively be carried out via network program(s). In such case, network program(s) might generate HTTP request(s). Such request(s) might include information such as URL(s) of basic save rate settings page(s) and/or value(s) to set for basic save rate(s). Next, such request(s) would be sent to image processing apparatus(es) 10. Image processing apparatus(es) 10 might carry out update processing by processing such request(s).

Note that storage unit access interface(s) 14f permitting access via network(s) may be such as to permit access by means of HTTP as indicated above and/or so as to permit access by means of SOAP and/or other such protocol(s).

Furthermore, in similar fashion as was the case at image processing apparatus 10, shared server 4 may be provided with storage unit access processor(s) 41a and storage unit access interface(s) 41b permitting access via network(s). Storage unit access processor(s) 41a process processing request(s) arriving at storage unit access interface(s) 41b. Storage unit access interface(s) 41b is/are interface permitting access to various types of information pertaining to image processing apparatus(es) 10. For example, storage unit access interface 41b might be able to access information such as number(s) of user(s) capable of accessing particular document(s) present on shared server(s) 4, format(s) of such document(s), and/or attribute(s) of such document(s). For example, if a request to return the number of users capable of accessing a particular document present on shared server 4, the number of users capable of accessing that document might be returned.

Note that storage unit access interface(s) 41b permitting access via network(s) may be such as to permit access by means of HTTP as indicated above and/or so as to permit access by means of SOAP and/or other such protocol(s).

The foregoing image processing apparatus(es) 10 may be provided with shared server access unit(s) 14m, and shared server(s) 4 may be provided with digital copier access unit(s) 41c. Where this is the case, it will be possible to access shared server(s) 4 from image processing apparatus(es) 10 and to acquire and/or update various information pertaining to shared server(s) 4. Furthermore, it will be possible to access image processing apparatus(es) 10 from shared server(s) 4 and to acquire and/or update various information pertaining to image processing apparatus(es) 10.

As described above, the present image processing apparatus 10 may serve as copier, printer, and/or scanner. Accordingly, while image processing apparatus 10 contributes to improvement in efficiency of office operations, there is also a possibility that it will be utilized in unauthorized fashion for personal rather than business purposes.

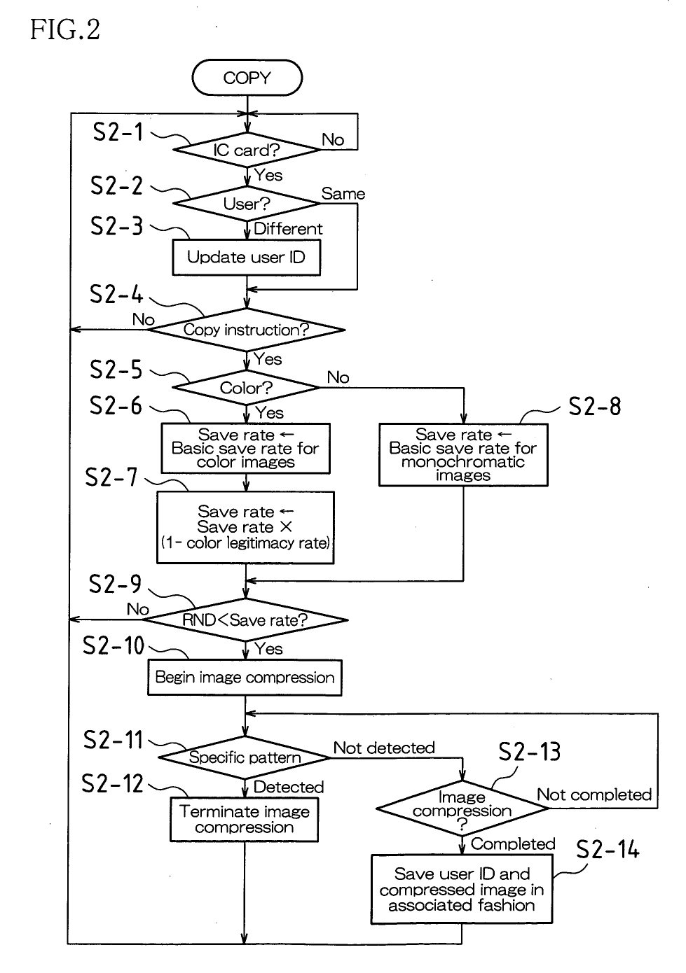

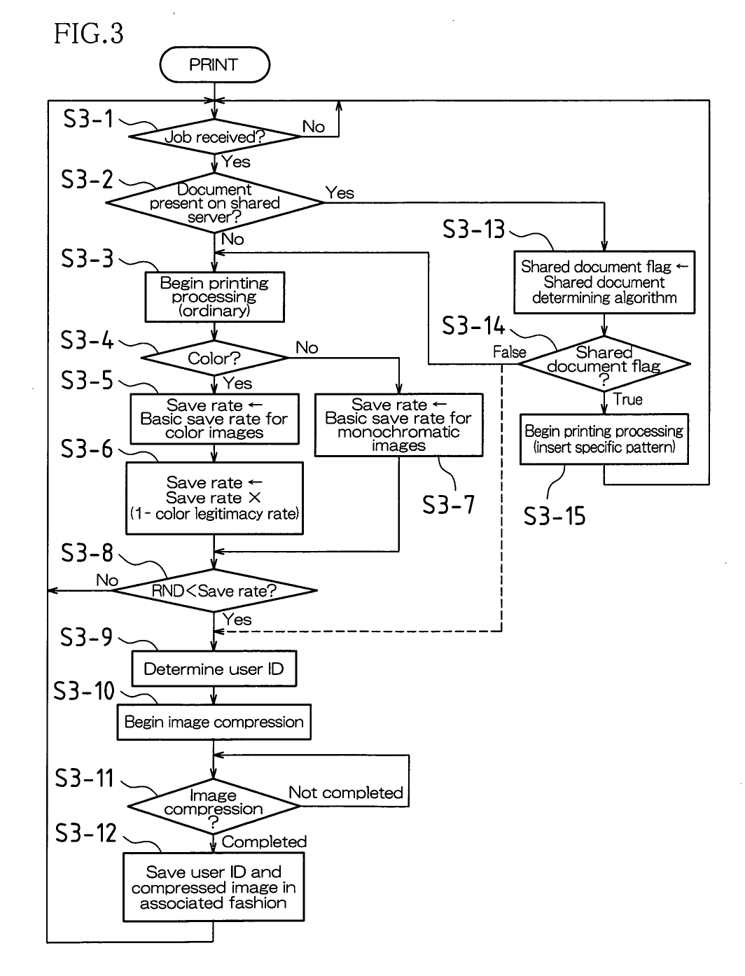

Therefore, when image processing apparatus 10 is made to serve as copier, by causing data monitoring apparatus(es) in accordance with the present embodiment to in parallel therewith carry out processing as at the flowchart indicated in FIG. 2, the ID number of the person (user) making use of image processing apparatus 10 and at least a portion of the image data are stored in mutually associated fashion. Similarly, when image processing apparatus 10 is made to serve as printer, by causing data monitoring apparatus(es) in accordance with the present embodiment to carry out processing as at the flowchart indicated in FIG. 3 in parallel therewith, ID number(s) of user(s) and at least a portion of the image data are stored in mutually associated fashion. By thus saving the ID number(s) of the user(s) and at least a portion of the image data in mutually associated fashion, it will be possible at any time to know which user(s) have been carrying out image processing on what data, making it possible to ascertain which user(s) have been engaging in unauthorized use of image processing apparatus(es) 10; and by reprimanding such user(s), it will be possible to inhibit unauthorized use.

2. Description of Operation

2.1 Copy Operations

Below, the flowchart of FIG. 2 is used to describe processing operations carried out when image processing apparatus 10 serves as copy machine.

At a time when copy processing operations are to be carried out, a user first inserts previously distributed IC card 18a into user ID input unit 18 of image processing apparatus 10. Alternatively or in addition thereto, noncontact tag 18b, capable of transmitting user ID(s) without coming in contact therewith, is brought close to user ID input unit 18.

User ID input unit 18 awaits insertion or the like of IC card 18a (“No” at step S2-1); and upon insertion of IC card 18a (“Yes” at step S2-1), reads the ID number of the user from this IC card 18a and outputs this ID number to controller 14. User ID identifying unit (identifying unit or identifying means) 14a of controller 14 accepts input of the ID number and compares this ID number with the ID number from the preceding storage operation (step S2-2); and in the event that this ID number does not match the preceding ID number (“Different” at step S2-2), updates ID number by storing this ID number and deleting the preceding ID number (step S2-3). But in the event that this ID number matches the preceding ID number (“Same” at step S2-2), the processing of step S2-3 is not carried out. Moreover, user ID identifying unit 14a communicates the ID number of IC card 18a to image save administration unit 14b.

Thereafter, an original image is placed on image capture component 11, and operations are carried out at user interface 16 so as to issue an instruction to carry out copying, an instruction to produce a monochromatic image being, for example, issued together therewith. Upon being instructed to carry out copying (“Yes” at step S2-4) and to produce a monochromatic image (“No” at step S2-5), mode unit 14c of controller 14 communicates to image save administration unit 14b, image capture component 11, image processing unit 12, and image forming unit 13 the fact that copying should be carried out and that a monochromatic image should be produced.

In response thereto, image capture component 11 captures an image of the original and outputs image data representing a monochromatic image. After being processed by image processing unit 12, this image data is input at image forming unit 13, where a monochromatic image is recorded onto recording paper.

Furthermore, image processing unit 12 also outputs image data to image save administration unit 14b of controller 14. Moreover, specific pattern detection unit 12a of image processing unit 12 attempts detection of specific pattern(s) (authentication pattern(s)) previously established for image data; and in the event that specific pattern(s) is/are detected within image data, outputs such specific pattern(s) to image save administration unit 14b of controller 14.

Furthermore, in response to communication from mode unit 14c of the fact that copying should be carried out and that a monochromatic image should be produced, save determining unit (determining unit or determining means) 14d of image save administration unit 14b calculates monochromatic image save rate (step S2-8). In calculating this save rate, save determining unit 14d refers to basic save rate table 14e shown in FIG. 16. The basic save rates listed herein include basic save rates for “monochromatic” and for “color” images. The basic save rate for color images is set so as to be higher (by a factor of 10) than that for monochromatic images.

The reason for this is so as to under basic circumstances allow color images to be saved at higher frequency than monochromatic images in order to permit more stringent monitoring of color images, since the expense incurred in recording a color image is typically greater than that incurred in recording a monochromatic image.

Save determining unit 14d reads a basic save rate in correspondence to whether copy processing being performed is monochromatic or color, randomly generates random number RND varying in 0.01 increments within the range 0 to 1.00, and compares this random number RND with the basic save rate for monochromatic images (step S2-9). Moreover, in the event that random number RND is less than the basic save rate (“Yes” at step S2-9), processing proceeds to step S2-10 and below in order to cause information linking that image data and the ID number of the user requesting processing thereof to be saved by storing same to storage unit (storage means) 15. But in the event that random number RND is greater than or equal to the basic save rate (“No” at step S2-9), image data is not saved and processing returns to step S2-1.

In the event that random number RND is less than the basic save rate (i.e., there having been a “Yes” at step S2-9) and processing has proceeded to step S2-10 and below, image reduction unit 14g of image save administration unit 14b carries out reduction processing (compression processing) on image data from image processing unit 12 (step S2-10). For this reduction processing, any existing method for reduction of images may be applied, there being no objection to employing even the simplest downsampling method in which respective pixels of the image are appropriately discarded.

In the event that, during the course of this image reduction processing, specific pattern detection unit 12a of image processing unit 12 detects presence of specific pattern(s) within image data (“Detected” at step S2-11) and this fact is communicated to image reduction unit 14g, image reduction unit 14g aborts the reduction processing being carried out on the image data (step S2-12). This is because, since specific pattern(s) is/are added to image data shared by a plurality of users but is/are not added to image data for personal use, copying of images which contain such specific pattern(s) does not constitute unauthorized use of image processing apparatus 10, and so there is no need to carry out reduction on or save the image data.

In the event that specific pattern(s) is/are not detected within image data (the value at step S2-11 continues to be “Not detected”) by the time of completion of such image reduction (by the time that the value at step S2-13 is “Completed”), image save administration unit 14b causes the reduced image data and the ID number of IC card 18a to be stored in mutually associated fashion at storage unit 15 (step S2-14).

On the other hand, upon receiving instruction from user interface 16 to carry out copying (“Yes” at step S2-4) and to produce a color image (“Yes” at step S2-5), the fact that copying should be carried out and that a color image should be produced is communicated from mode unit 14c to image save administration unit 14b, image capture component 11, image processing unit 12, and image forming unit 13.

In response thereto, image capture component 11 captures an image of the original and outputs image data representing a color image. Moreover, this image data is processed by image processing unit 12, and a color image is recorded onto recording paper by image forming unit 13.

Furthermore, the image data is output from image processing unit 12 to image save administration unit 14b of controller 14, and specific pattern detection unit 12a of image processing unit 12 attempts to detect specific pattern(s) within the image data.

Furthermore, in response to communication from mode unit 14c of the fact that copying should be carried out and that a color image should be produced, save determining unit 14d of image save administration unit 14b calculates color image save rate (steps S2-6 and S2-7). In calculating this save rate, save determining unit 14d refers to basic save rate table 14e shown in FIG. 16 and user data table 14o shown in FIG. 17. At user data table 14o, stored in correspondence to ID number for a plurality of users are the name of the user and a color legitimacy rate for color images. Save determining unit 14d might, for example, read a basic save rate of 0.60 for color images from basic save rate table 14e and might read the color legitimacy rate corresponding to the ID number of IC card 18a from user data table 14o, and might calculate an applicable save rate by means of the operation “(1−color legitimacy rate)×basic save rate 0.60”. For example, if color legitimacy rate is 0.60, then this would be calculated as “(1−0.60)×0.60=0.24” to yield an applicable save rate of 0.24.

In addition, save determining unit 14d randomly generates random number RND varying in 0.01 increments within the range 0 to 1.00, and compares this random number RND with applicable save rate 0.24 (step S2-9). Moreover, in the event that random number RND is less than applicable save rate 0.24 (“Yes” at step S2-9), processing proceeds to step S2-10 and below in order to cause image data representing the color image to be stored and saved. But in the event that random number RND is greater than or equal to applicable save rate 0.24 (“No” at step S2-9), image data is not saved and processing returns to step S2-1.

In the event that image data representing color image(s) is to be stored and saved, in similar fashion as was the case for monochrome image(s), reduction processing is carried out on image data from image processing unit 12 (step S2-10). In the event that, during the course of this image reduction, specific pattern detection unit 12a of image processing unit 12 detects presence of specific pattern(s) within image data (“Detected” at step S2-11), because this means that this image data is shared by a plurality of users, the reduction processing being carried out on the image data is aborted (step S2-12). Furthermore, in the event that specific pattern(s) is/are not detected within image data (the value at step S2-11 continues to be “Not detected”) by the time of completion of such image reduction (by the time that the value at step S2-13 is “Completed”), image save administration unit 14b causes the reduced image data and the ID number of the IC card to be stored in mutually associated fashion at storage unit 15.

2.2 Print Operations

Next, the flowchart of FIG. 3 is used to describe processing operations carried out when image processing apparatus 10 serves as printer.

As already described, image processing apparatus 10 receives image data from respective user terminal(s) 2 and/or shared server(s) 4, and carries out recording of image(s) represented by this image data. Administrator(s) of image processing apparatus(es) 10 cause list(s) of address(es) of shared server(s) 4 to be entered in shared server list(s). Administrator(s) enter address(es) of shared server(s) 4 thereinto from user interface(s) 16 and/or storage unit access interface(s) 14f. At image processing apparatus(es) 10, data identifying unit(s) 14h of controller(s) 14 await reception of image data from network cable(s) 5 by way of network interface(s) 17 (“No” at step S3-1); and upon reception of image data (“Yes” at step S3-1), extract header(s) attached to such image data, and read from the header(s) the address(es) of the user terminal(s) 2 which sent the image data. Moreover, whether address(es) is/are that or those of shared server(s) 4 is determined by looking at shared server list(s).

If address(es) read from header(s) is/are not that or those of shared server(s) 4 (“No” at step S3-2), printing processing for printer function is initiated (step S3-3). Data identifying unit(s) 14h read from header(s) whether instruction(s) is/are such as to require production of monochromatic image(s) or color image(s); communicate whether monochromatic image(s) or color image(s) should be produced to image processing unit(s) 12 and image save administration unit(s) 14b; and deliver image data to image processing unit(s) 12 and image save administration unit(s) 14b. Image processing unit(s) 12 process image data and then deliver same to image forming unit(s) 13. At image forming unit(s) 13, monochromatic image(s) or color image(s) represented by the image data is/are recorded onto recording paper.

Moreover, in the event that an instruction is such as to require production of a monochromatic image (“No” at step S3-4), save determining unit 14d of image save administration unit 14b carries out processing similar to that described above with reference to step S2-8 of FIG. 2 and calculates basic save rate for the monochromatic image (step S3-7). In addition, in the event that random number RND is less than the basic save rate (“Yes” at step S3-8), the address(es) of the user terminal(s) 2, and the ID number(s) of the user(s) at the user terminal(s) 2, are read from the header(s) which was or were sent thereto and are communicated to image save administration unit(s) (step S3-9).

Furthermore, processing proceeds to step S3-10 and below in order to cause image data representing the monochromatic image to be stored and saved. But in the event that random number RND is greater than or equal to the basic save rate (“No” at step S3-8), image data is not saved and processing returns to step S3-1.

At step S3-10, image reduction unit 14g of image save administration unit 14b carries out reduction processing on image data. In addition, upon completion of image reduction (“Completed” at step S3-11), image save administration unit 14b causes the reduced image data and the ID number of IC card 18a to be stored in mutually associated fashion at storage unit 15 (step S3-12).

But in the event that an instruction requiring production of a color image is read from the header of the received image data (“Yes” at step S3-4), save determining unit 14d of image save administration unit 14b carries out processing similar to that described above with reference to steps S2-6 and S2-7 of FIG. 2 and calculates applicable save rate for the color image (steps S3-5 and S3-6). Moreover, in the event that random number RND is less than the applicable save rate (“Yes” at step S3-8), processing proceeds to step S3-9 and below in order to cause image data representing the color image to be stored and saved. But in the event that random number RND is greater than or equal to the applicable save rate (“No” at step S3-8), image data is not saved and processing returns to step S3-1.

Likewise, in the event that image data representing color image(s) is to be saved, image data is reduced (steps S3-10 and S3-11), and the reduced image data and the ID number of IC card 18a are stored in mutually associated fashion at storage unit 15 (step S3-12).

Thus, during use of image processing apparatus 10, at least a portion of the data which is recorded and the ID number(s) of the user(s) are stored in mutually associated fashion at storage unit(s) 15. This being the case, it is possible by retrieving stored content at storage unit(s) 15 to know which user(s) have been recording what data, making it possible to become aware of unauthorized use of image processing apparatus(es) 10 and making it possible to inhibit same.

But in the event that address(es) read from header(s) is/are that or those of shared server(s) 4 (“Yes” at step S3-2), processing proceeds to step S3-13 and below. Also stored within header(s) is image data location information including name(s) of document(s) on shared server 4, and such information is read at step S3-13. Next, “shared document determining algorithm(s)” carried out at algorithm execution unit(s) 14p, described below, is/are applied to such document(s), and shared document flag(s) indicating whether such document(s) is/are shared document(s) is/are set. “Shared document determining algorithms” are algorithms for determining whether document(s) at shared server(s) 4 is/are shared by a plurality of users (whether document(s) is/are not for personal use).

In the event that it is not determined as a result of such algorithm(s) that source document(s) for image data is/are shared document(s) (“False” at step S3-14), processing at step S3-3 and below is carried out. That is, together with execution of printing processing, determination as to whether such image data should be stored and saved together with ID number(s) is made in correspondence to save rate(s). Here as well, in the event that random number RND is less than save rate, at least a portion of the image data and the ID number(s) of the user(s) are stored in mutually associated fashion at storage unit(s) 15. This being the case, it is possible by retrieving stored content at storage unit(s) 15 to know which user(s) have been recording what data which is present on shared server(s) 4, making it possible to become aware of unauthorized use of image processing apparatus(es) 10 and making it possible to inhibit same.

Alternatively, as indicated by the arrow drawn with broken line at FIG. 3, in the event that it is not determined as a result of such algorithm(s) that source document(s) for image data is/are shared document(s) (“False” at step S3-14), it is possible to carry out processing at step S3-9 and below. That is, operation in such case is such that at least a portion of the image data and the ID number(s) of the user(s) are stored in mutually associated fashion at storage unit(s) 15 without carrying out printing processing and without regard to save rate.

The foregoing operation(s) may be carried out during copy operations and/or print operations. This being the case, the data monitoring apparatus associated with the present embodiment comprises user ID identifying unit(s) 14a, storage unit(s) 15, save determining unit(s) 14d, and algorithm execution unit(s) (evaluating unit(s) and/or evaluating means) 14p.

3. Description of Shared Document Determining Algorithm

Several examples of shared document determining algorithms are described below. At step S3-13 in the flowchart of FIG. 3, shared document determining algorithm(s) are executed in order to set shared document flag(s). Note that it is not intended that “shared document determining algorithm(s)” should refer to only those indicated below, as it is possible to envision a wide variety of forms such algorithms might assume.

3.1 Shared Document Determining Algorithm 1

This algorithm checks to see whether document(s) in question (data subject to monitoring) present on shared server(s) 4 permit access by at least some fixed number of users; and in the event that such document(s) do not so permit, it is determined that there is a high probability that such document(s) is/are not shared; i.e., that such document(s) is/are involved in unauthorized use.

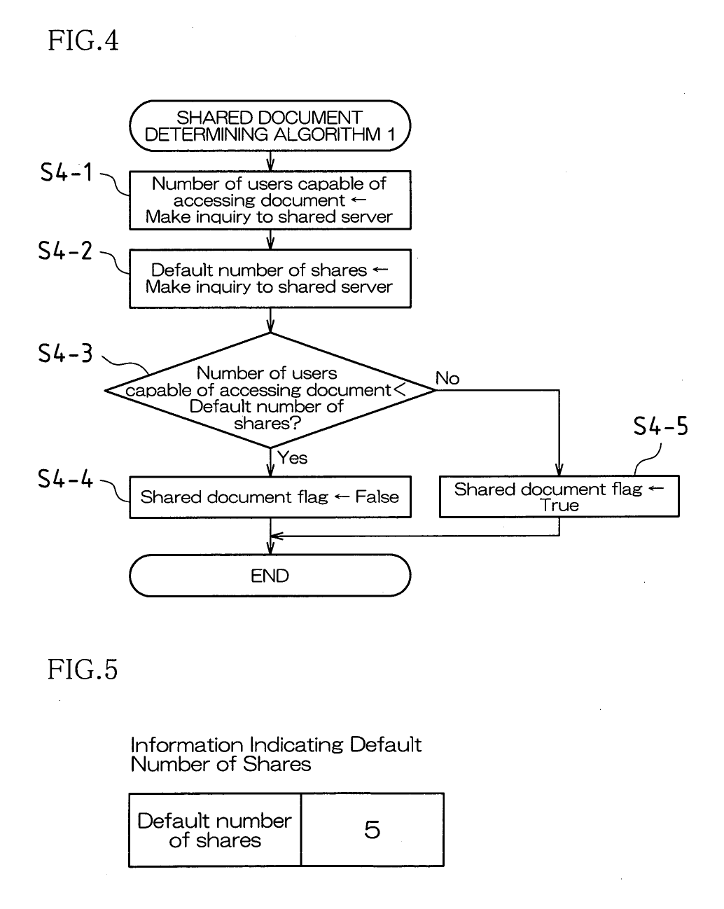

FIG. 4 is a flowchart showing operations in accordance with Shared Document Determining Algorithm 1. Below, description is carried out using this FIG. 4.

At a time when image processing apparatus 10 is determining whether a source document for image data is present on shared server 4, the name of the source document for the image data might also be acquired from the header (step S3-2 in FIG. 3). Moreover, this information is acquired when inquiry is made to shared server 4 as to the number of users capable of accessing that document at shared server 4 (step S4-1). Acquisition of this number of users occurs as a result of the fact that shared server access unit 14m within image processing apparatus 10 accesses storage unit access interface 41b of shared server 4.

Next, the number of users capable of accessing that document is compared with the default number of shares shown in FIG. 5. Information containing the default number of shares shown in FIG. 5 is retained by shared server 4 at storage unit 43. By referring to this default number of shares it is possible to find out what the default number of shares is for the document. The default number of shares might be acquired by inquiring for same from shared server 4 (step S4-2). In the event that it is found as a result thereof that the number of users capable of accessing the document is less than the default number of shares (“Yes” at step S4-3), it is determined that the document is not a shared document, and the shared document flag is set to “False” (step S4-4). On the other hand, in the event that the number of users capable of accessing that document is greater than or equal to the default number of shares (“No” at step S4-3), it is determined that the document is a shared document, and the shared document flag is set to “True” (step S4-5).

3.2 Shared Document Determining Algorithm 2

This algorithm checks to see whether format(s) as determined from file extension(s) of document(s) in question present on shared server(s) 4 match actual format(s) of such document(s); and in the event that the two do not match, it is determined that such document(s) is/are not shared.

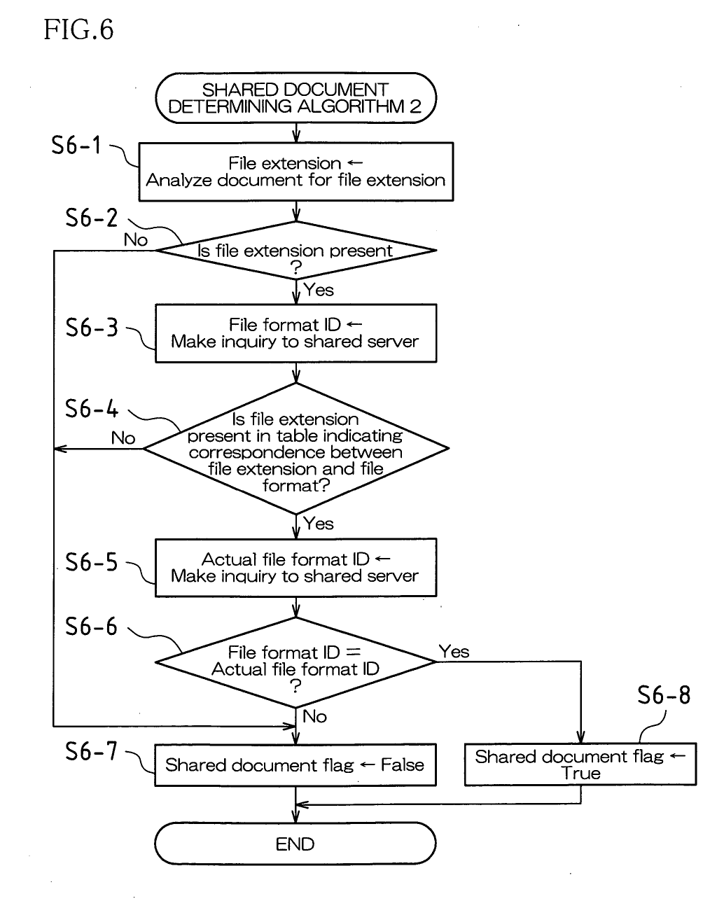

FIG. 6 is a flowchart showing operations in accordance with Shared Document Determining Algorithm 2. Below, description is carried out using this FIG. 6.

At a time when image processing apparatus 10 is determining whether a source document for image data is present on shared server 4, the name of the source document for the image data might also be acquired from the header (step S3-2 in FIG. 3). Moreover, the file extension of the document might be acquired by analyzing the name of that document (step S6-1) (e.g., the file extension of “important.jpg” would be “jpg”). In the event that it is found as a result thereof that there is no file extension (“No” at step S6-2), it is determined that this document is not a shared document, and the shared document flag is set to “False” (step S6-7).

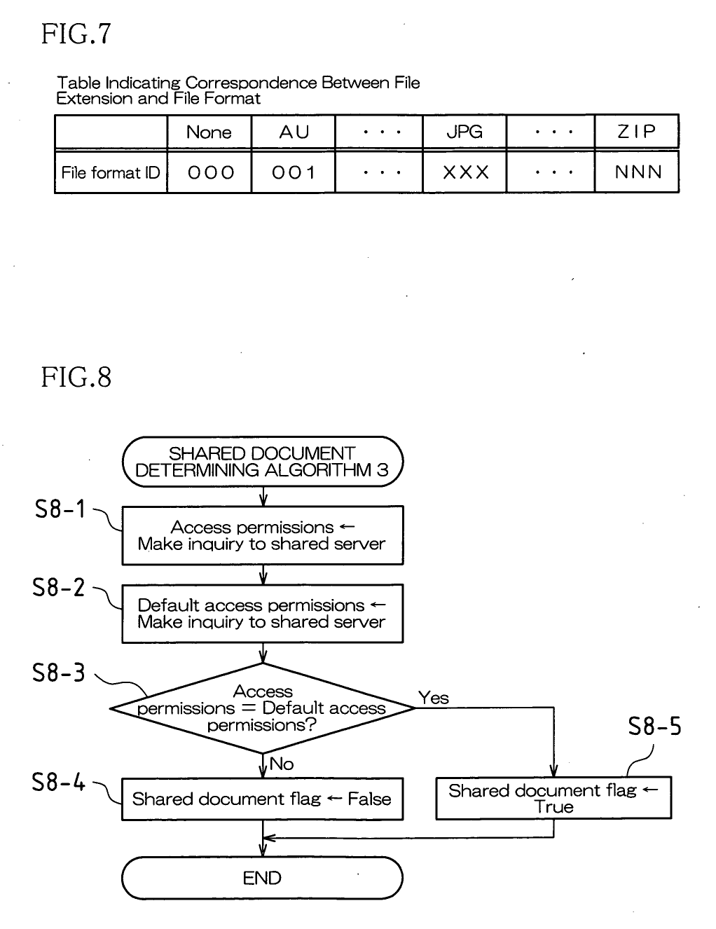

On the other hand, in the event that there is a file extension (“Yes” at step S6-2), inquiry is made to shared server(s) 4 as to the file format ID(s) corresponding to that file extension (step S6-3). Shared server(s) 4 check to see whether that file extension is present within the table indicating correspondence between file extension and file format shown in FIG. 7. The table indicating correspondence between file extension and file format shown in FIG. 7 is retained by shared server 4 at storage unit 43. This correspondence table stores individual file format IDs in correspondence to various file extensions. By referring to this correspondence table it is possible to see what file extensions there are as well as the file format IDs corresponding thereto. In the event that it is found as a result of referring thereto that the file extension is not present within the correspondence table shown in FIG. 7 (“No” at step S6-4), it is determined that this document is not a shared document, and the shared document flag is set to “False” (step S6-7).

And in the event that it is found that the file extension is present within the correspondence table shown in FIG. 7 (“Yes” at step S6-4), inquiry is thereafter made to shared server(s) 4 as to the actual file format ID(s) of the source document(s) (step S6-5). Such actual file format ID(s) may be detected as a result of analysis performed by actual format detecting unit(s) 41d provided at shared server(s) 4.

Next, the file format ID obtained at step S6-3 is compared with the actual file format ID obtained at step S6-5 (step S6-6). In the event that it is found as a result thereof that the file format ID is not equal to the actual file format ID (“No” at step S6-6), it is determined that this document is not a shared document, and the shared document flag is set to “False” (step S6-7).

On the other hand, in the event that it is found that the file format ID is equal to the actual file format ID (“Yes” at step S6-6), it is determined that this document is a shared document, and the shared document flag is set to “True” (step S6-8).

Note that shared server(s) 4 may employ existing algorithm(s) to determine actual file format(s). For example, it is possible to employ algorithm(s) used by the UNIX “file” command.

3.3 Shared Document Determining Algorithm 3

This algorithm looks at access permission(s) of document(s) in question present on shared server(s) 4; and in the event that access permission(s) of such document(s) differ from default access permission(s), it is determined that such document(s) is/are not shared.

FIG. 8 is a flowchart showing operations in accordance with Shared Document Determining Algorithm 3. Below, description is carried out using this FIG. 8.

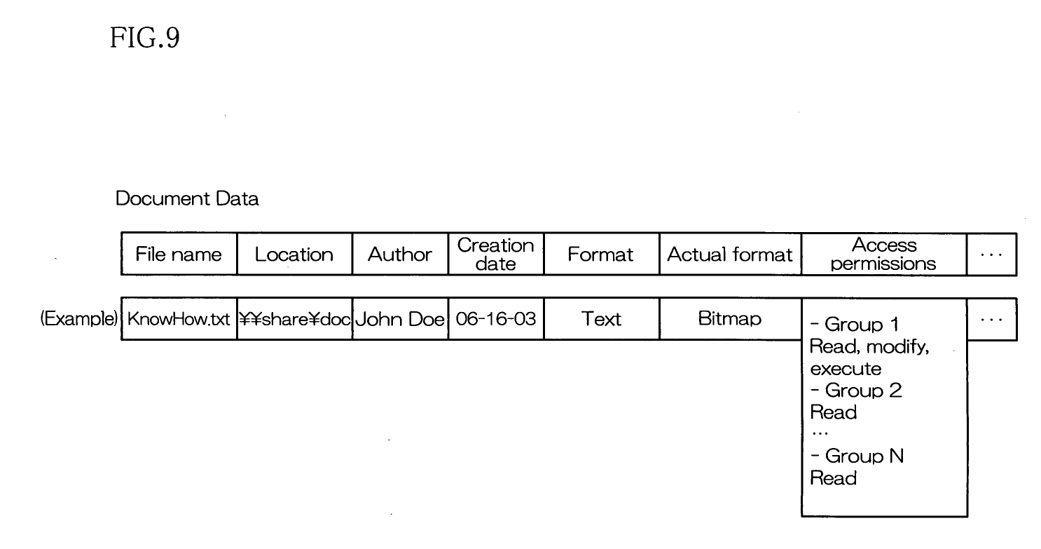

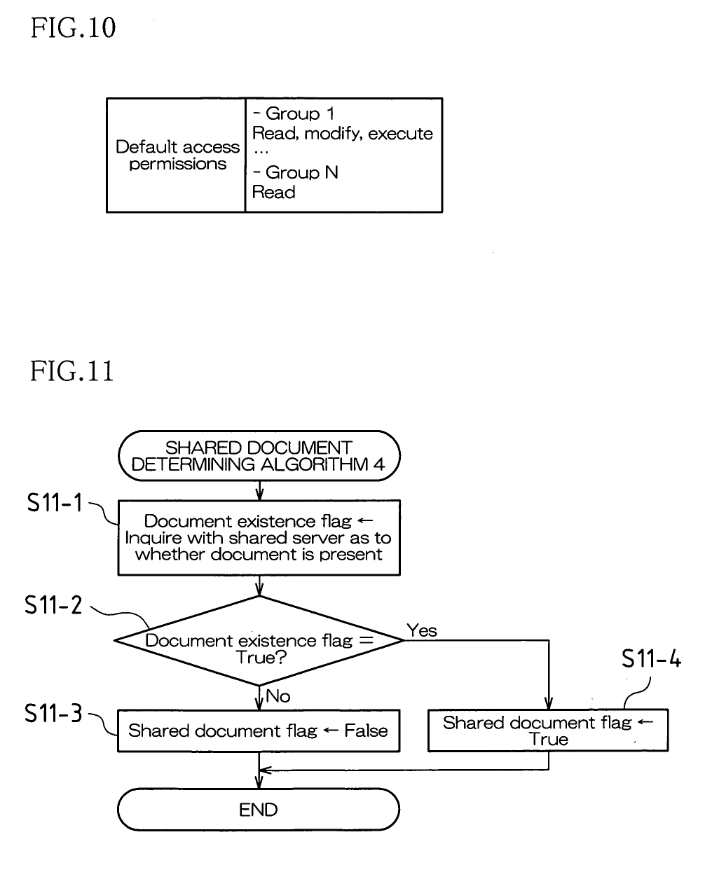

At a time when image processing apparatus 10 is determining whether a source document for image data is present on shared server 4, the name of the source document for the image data might also be acquired from the header (step S3-2 in FIG. 3). Moreover, access permission(s) for that document might be acquired by inquiring for same from shared server 4 (step S8-1). The document data shown in FIG. 9 and the default access permissions shown in FIG. 10 are retained by shared server 4 at storage unit 43. Stored at the document data shown in FIG. 9 is data pertaining to document(s). File name, location, author, creation date, format, actual format, and access permissions might, for example, be stored thereat. By referring to such document data it is possible to find out what the attributes of a document are. Stored under “access permissions” is information describing which group(s) and/or which user(s) may carry out what sort(s) of operation(s) on the document. Stored at the default access permissions shown in FIG. 10 are default access permissions that document(s) present on shared server(s) 4 are supposed to have. By referring to such default access permissions it is possible to find out what the default access permissions are for document(s) present on shared server(s) 4. Next, default access permission(s) are acquired by inquiring for same from shared server 4 (step S8-2). In addition, the access permissions acquired at step S8-1 are compared with the default access permissions acquired at step S8-2 (step S8-3). In the event that it is found as a result of comparison that the access permissions are not equal to the default access permissions (“No” at step S8-3), it is determined that the document is not a shared document, and the shared document flag is set to “False” (step S8-4).

On the other hand, in the event that it is found that the access permissions are equal to the default access permissions (“Yes” at step S8-3), it is determined that the document is a shared document, and the shared document flag is set to “True” (step S8-5).

3.4 Shared Document Determining Algorithm 4

This algorithm looks to see whether document(s) in question is/are present on shared server(s) 4; and in the event that such document(s) is/are not present, it is determined that such document(s) is/are not shared.

FIG. 11 is a flowchart showing operations in accordance with Shared Document Determining Algorithm 4. Below, description is carried out using this FIG. 11. When this algorithm is launched, the name of the source document for the image data might be acquired from the header of the received image data (step S3-2 in FIG. 3). Moreover, inquiry might be made as to whether that document is present on shared server(s) 4 (step S11-1). In the event that the foregoing document is present, a document existence flag is set to “True”. In the event that the foregoing document is not present, the document existence flag is set to “False”.

Next, the document existence flag is examined (step S11-2). In the event that the document existence flag is equal to “False” (“No” at step S11-2), it is determined that this document is not a shared document, and the shared document flag is set to “False” (step S11-3).

On the other hand, in the event that the document existence flag is equal to “True” (“Yes” at step S11-2), it is determined that this document is a shared document, and the shared document flag is set to “True” (step S11-4).

This completes description of respective shared document determining algorithms. Whereas at the foregoing descriptions a single shared document determining algorithm was used to determine whether document(s) present on shared server(s) 4 is/are shared, the present invention is not limited hereto, it also being possible to contemplate methods in which a plurality of shared document determining algorithms are respectively applied as subalgorithms to document(s) in question present on shared server(s) 4, results of respective determinations made at such plurality of subalgorithms being further subjected to determining algorithm(s) to determine whether document(s) is/are shared. Detailed description follows.

3.5 Shared Document Determining Algorithm α

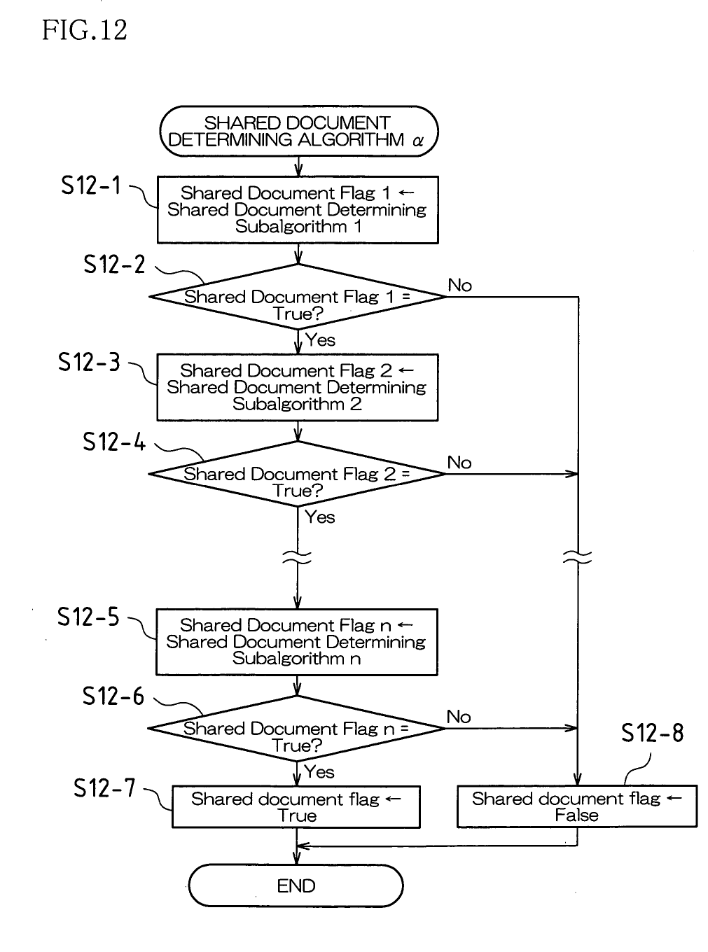

FIG. 12 is a flowchart of Shared Document Determining Algorithm a, this being an example of combined use of n shared document determining subalgorithms. This Shared Document Determining Algorithm α comprises n shared document determining subalgorithms that are sequentially applied to document(s) present on shared server(s) 4 (steps S12-1, S12-3, . . . S12-5), the shared document flag being set to “True” only if it is determined at all shared document determining subalgorithms that the document is shared (i.e., only if the values at steps S12-2, S12-4, . . . S12-6 are all “Yes”). In such case, because a document will not be determined to be shared unless it successfully passes through the n shared document determining subalgorithms (i.e., unless the value is “True” at all subalgorithms), this permits rigorous examination.

Furthermore, as a derivative of Shared Document Determining Algorithm α shown in FIG. 12, it is possible, for example, to contemplate an embodiment in which previously established threshold value and counter are employed, the counter being advanced with successful passage through each of the shared document determining subalgorithms, and the document being determined to be shared when the counter exceeds the threshold value.

3.6 Shared Document Determining Algorithm β

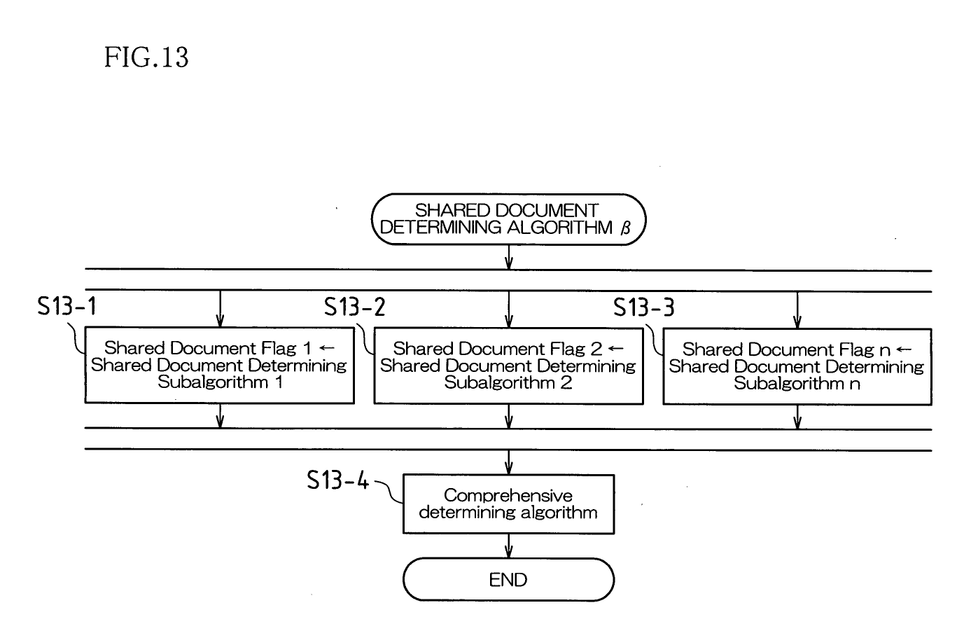

FIG. 13 is a flowchart of Shared Document Determining Algorithm β, this being another example of combined use of n shared document determining subalgorithms. This Shared Document Determining Algorithm β comprises n shared document determining subalgorithms that are applied in asynchronous fashion to document(s) present on shared server(s) 4 (steps S13-1, S13-2, . . . S13-3), determination as to whether a document is shared being carried out by applying the respective subalgorithms and thereafter using comprehensive determining algorithm(s) to evaluate the results output by the n subalgorithms (step S13-4). Output results might be such that Shared Document Determining Flag 1, Shared Document Determining Flag 2, . . . , Shared Document Determining Flag n are respectively obtained from Shared Document Determining Subalgorithm 1, Shared Document Determining Subalgorithm 2, . . . , Shared Document Determining Subalgorithm n.

While it is possible to envision a variety of forms that might be assumed by the comprehensive determining algorithm used with Shared Document Determining Algorithm α, some examples are indicated below.

3.6.1 Comprehensive Determining Algorithm 1

This Comprehensive Determining Algorithm 1 performs a logical AND on the outputs from the n shared document determining subalgorithms, and is equivalent to the operations at the flowchart shown in the foregoing FIG. 12.

Shared document flag=(Shared Document Flag 1) AND (Shared Document Flag 2) AND . . . AND (Shared Document Flag n)

In such case, because the shared document flag on the left side of the equation will be “False” unless all of the shared document flags on the right side of the equation are “True”, this permits rigorous checking of the document.

3.6.2 Comprehensive Determining Algorithm 2

This Comprehensive Determining Algorithm 2 performs a logical OR on the outputs from the n shared document determining subalgorithms.

Shared document flag=(Shared Document Flag 1) OR (Shared Document Flag 2) OR . . . OR (Shared Document Flag n)

In such case, because the shared document flag on the left side of the equation will be “True” if even one of the shared document flags on the right side of the equation is “True”, this permits loose checking of the document.

3.6.3 Comprehensive Determining Algorithm 3

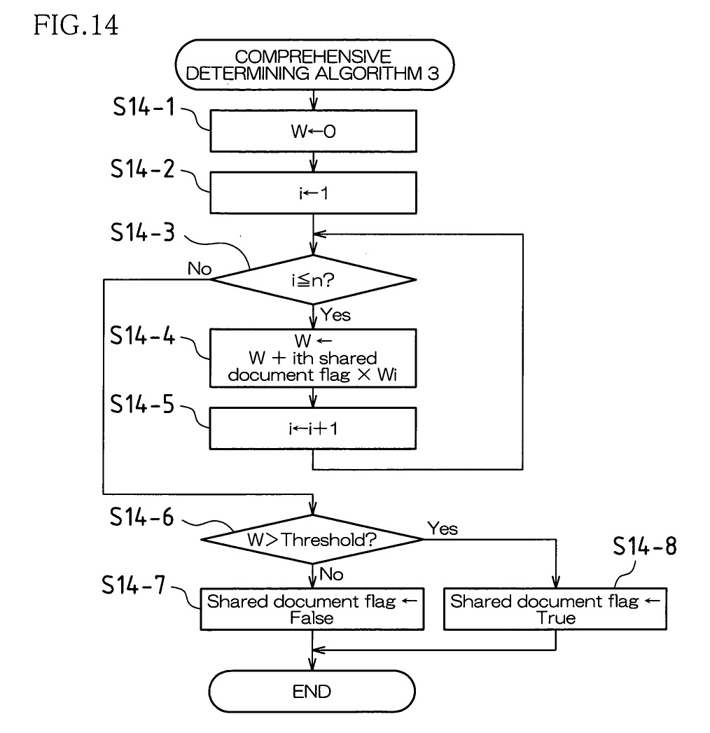

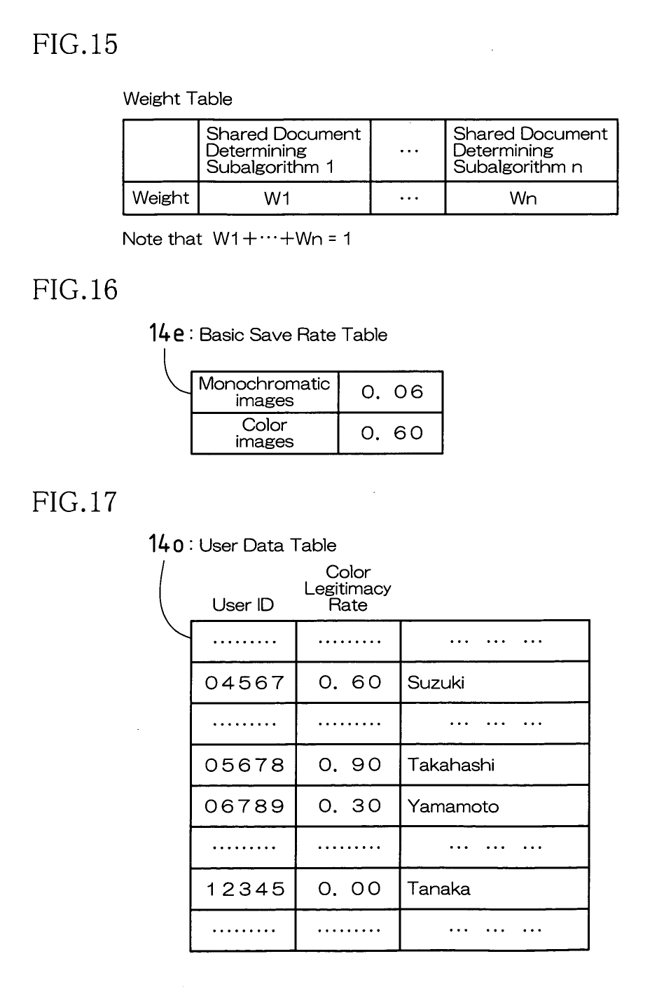

FIG. 14 is a flowchart showing operations in accordance with Comprehensive Determining Algorithm 3. FIG. 15 shows a table containing weights applied to respective shared document determining subalgorithms, these being referred to throughout this flowchart. Below, description of this Comprehensive Determining Algorithm 3 is carried out using FIG. 14. This algorithm is executed after the n shared document determining subalgorithms have been executed in asynchronous fashion (after the operations at S13-1 through S13-3 in the flowchart of FIG. 13 have been executed).

First, variable W is initialized to “0” (step S14-1). Next, variable i, having value corresponding to the ordinal number of the shared document determining subalgorithm being executed, is initialized to “1” (step S14-2). Next, variable i is compared to n. If i is greater than n (“No” at step S14-3), then W is compared to the threshold (step S14-6). If W is less than or equal to the threshold (“No” at step S14-6), then the shared document flag is set to “False” (step S14-7). Conversely, if W is greater than the threshold (“Yes” at step S14-6), then the shared document flag is set to “True” (step S14-8).

On the other hand, if i is less than or equal to n (“Yes” at step S14-3), then variable W is redefined to be the existing value of W plus the product of the ith shared document flag and the weight Wi applicable to the ith shared document determining subalgorithm (as indicated at the weight table of FIG. 14, these weights Wi are separately established in advance in correspondence to the degree of reliability of the respective shared document determining subalgorithms) (step S14-4). The product of the ith shared document flag and the weight Wi applicable to the ith shared document determining subalgorithm is defined to be equal to “Wi” when the shared document flag is “True”, and to be “0” when the shared document flag is “False”. Next, the value of variable i is increased by 1 (step S14-5). Processing thereafter returns to step S14-3.

Whereas the algorithms and/or subalgorithms described above with reference to FIGS. 4 through 15 were implemented with image processing apparatus(es) 10 making inquiry to shared server(s) 4 in consecutive fashion, method(s) for implementing algorithms and/or subalgorithms is/are not limited only to methods in which image processing apparatus(es) 10 make inquiry to shared server(s) 4 in consecutive fashion. For example, methods might also be contemplated in which storage unit access interface(s) 41b of shared server(s) 4 is/are provided with inquiry handler(s) specially designed for such algorithm(s) and/or subalgorithm(s), and in which image processing apparatus(es) 10 access such inquiry handler(s). Where this is the case, image processing apparatus(es) 10 might need only make a single inquiry to shared server(s) 4.

Next, processing proceeds to that which follows execution of shared document determining algorithm(s). The course of the processing to be performed next varies depending upon whether the shared document flag is “True” or “False”. In the event that the shared document flag is “False” (“False” at step S3-14), processing proceeds to step S3-3 and below in FIG. 3. That is, as described above, together with execution of printing processing, determination as to whether such image data should be stored and saved together with ID number(s) is made in correspondence to save rate(s); and in the event that random number RND is less than save rate(s), at least a portion of the image data and the ID number(s) of the user(s) are stored in mutually associated fashion at storage unit(s) 15.

But in the event that the shared document flag is “True” (“True” at step S3-14), processing proceeds to step S3-15 and below in FIG. 3. These are the operations that are carried out in the event that it is determined that image data is data that has been created from shared document(s). That is, data identifying unit(s) 14h read from header(s) whether instruction(s) is/are such as to require production of monochromatic image(s) and/or color image(s), and communicate whether monochromatic image(s) and/or color image(s) should be produced to image processing unit(s) 12 (step S3-15). Furthermore, specific pattern insertion unit(s) 14n of controller(s) 14 insert pattern data representing specific pattern(s) into image data and thereafter deliver this image data to image processing unit(s) 12, and processing returns to step S3-1.

After being processed by image processing unit(s) 12, this image data is input at image forming unit(s) 13, where monochromatic image(s) or color image(s) is recorded onto recording paper. The specific pattern(s) is/are contained within such recorded image(s). Therefore, in the event that it is determined as a result of shared document determining algorithm(s) that source document(s) for image data received from shared server(s) 4 is/are shared document(s), image data is not saved but image(s) containing specific pattern(s) is/are recorded. This is because, when it has been determined that such document(s) is/are shared document(s), since such document(s) is/are shared by a plurality of users, recording of image(s) does not constitute unauthorized use of image processing apparatus(es) 10, so there is no need to save image data.

Moreover, if the recording paper onto which such printing was carried out (recording paper onto which printing of image(s) to which specific pattern(s) has or have been attached has been carried out) were to be copied, because specific pattern(s) would be detected at step S2-11 of FIG. 2 as has been described above, image data representing such image(s) would not be saved to storage unit(s) 15.

In accordance with the present embodiment as described above, even where data received by image processing apparatus(es) 10 is image data that has been created from document(s) present on shared server(s) 4, determination is carried out with respect to shareability at shared server(s) 4 of the source document(s) for that image data. Moreover, where it is determined that such document(s) is/are determined not to be shareable, this is determined to be unauthorized use, and information linking at least a portion of the image data and the ID(s) of user(s) requesting image processing of such image data is caused to be stored at storage unit(s) 15, permitting suppression of unauthorized use. This permits improvement on conventional techniques in which determination as to unauthorized use was not carried out for document(s) on shared server(s) 4, document(s) on shared server(s) 4 being unconditionally being determined to be shareable with such conventional techniques. This being the case, it is possible suppress unauthorized use of image processing apparatus(es) 10 occurring through exploitation of shared server(s) 4.

Furthermore, save determining unit 14d determines whether storage of information to storage unit(s) 15 should be carried out such that there is a higher information save rate when carrying out processing of color image(s) than when carrying out processing of monochromatic image(s). That is, in light of the fact that greater expense is incurred in recording color data onto recording paper than is incurred in recording monochromatic data thereonto, even where circumstantial conditions are otherwise identical, color save rate(s) might be made higher than monochromatic save rate(s) so as to increase the frequency with which color data is stored to storage unit(s) 15. This makes it possible to increase stringency of monitoring for unauthorized use of image processing apparatus(es) 10 during processing of color image(s), making it possible to achieve reduced losses due to unauthorized use.

Moreover, in accordance with the present embodiment, information save rate(s) can be varied by user depending upon whether user(s) have need to record color image(s). For example, in an office setting, users involved in accounting, management, and the like might have little occasion to record color images, while users involved in planning, design, and the like might have frequent occasion to record color images. It is for this reason that, as has been described above, a basic save rate for color images is read from basic save rate table 14e shown in FIG. 16 and a color legitimacy rate corresponding to the user is read from user data table 14o shown in FIG. 17, and an applicable save rate for the user is calculated by means of the operation “(1−color legitimacy rate)×basic save rate”, with saving of color images taking place at this applicable save rate. As a result of such processing operations, it is possible to reduce the amount of data that must be stored, it is possible to achieve improved economy with respect to storage capacity or capacities of storage unit(s) 15, and it is possible to make more easy the administrative tasks of retrieving content from storage unit(s) 15 and ascertaining whether unauthorized use of image processing apparatus(es) 10 has occurred.

Furthermore, in the present embodiment, because reduction processing is carried out on image data before the image data is stored, the amount of data which must be stored is reduced and the administrative tasks of ascertaining whether unauthorized use has occurred is made more easy.

### Embodiment 2

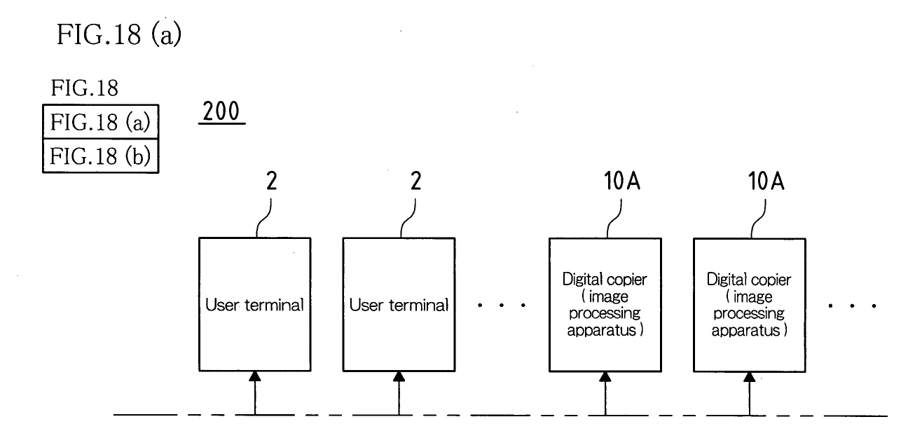

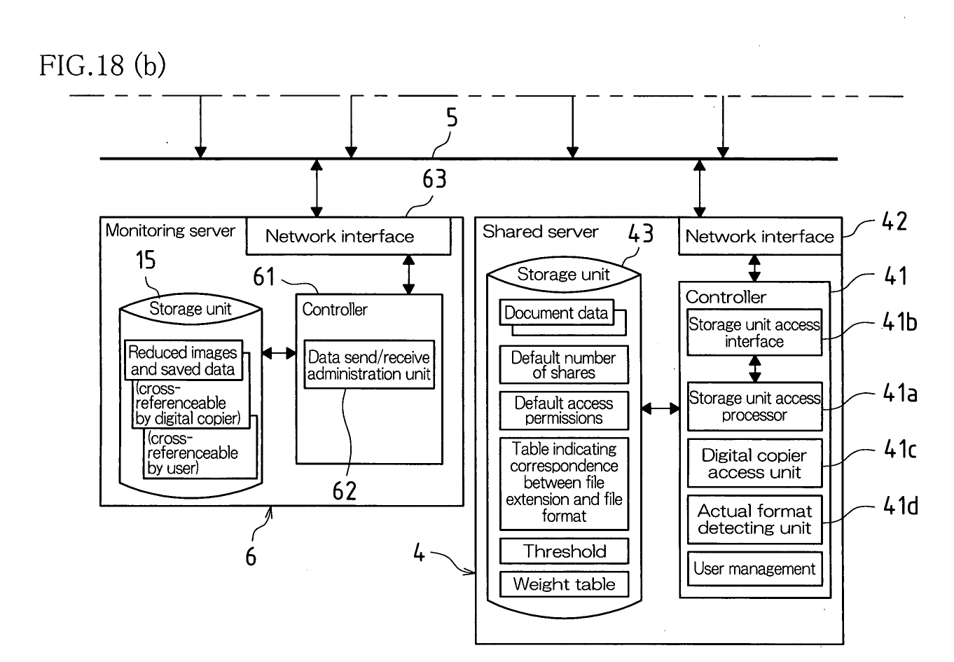

Next, a second embodiment of the present invention is described. As shown in FIG. 18, in the present embodiment, the present invention is applied to a network system 200 in which a plurality of user terminals 2, a plurality of image processing apparatuses 10A, shared server(s) 4, and monitoring server(s) 6 are connected network (LAN). Note that in the description that follows, only those aspects which are different from the first embodiment are described.

As shown in FIG. 18, network system 200 associated with the present embodiment is provided with separate monitoring server(s) 6, and such monitoring server(s) 6 is/are equipped with storage unit(s) 15. That is, information linking user-identifying information (ID number(s)) and image data is stored not at image processing apparatus(es) 10A but at monitoring server(s) 6. Note that image processing apparatus 10A is in other respects identical to image processing apparatus 10 of the first embodiment.

Data send/receive administration unit(s) 62 provided at controller(s) 61 of monitoring server(s) 6 is/are capable of accessing public interface(s) of image processing apparatus(es) 10A and/or shared server(s) 4. Such data send/receive administration unit(s) 62 is/are also capable of receiving data sent thereto from image processing apparatus(es) 10A.

At such a monitoring server 6, when it has been determined that information should be stored to storage unit(s) 15 (in the event that at the flowchart shown in FIG. 2 the value at step S2-9 is “Yes” and the value at step S2-13 is “Completed”; in the event that at the flowchart shown in FIG. 3 the value at step S3-2 is “Yes” and the value at step S3-14 is “False”; in the event that at the flowchart shown in FIG. 3 the value at step S3-2 is “No” and the value at step S3-8 is “Yes”; and so forth), information linking image data and user-identifying information and information related to image processing apparatus(es) 10A (host name(s), IP address(es), time(s) at which unauthorized printing occurred, etc.) is received at network interface(s) 63 by way of network cable(s) 5 from image processing apparatus(es) 10A, and such information is input at controller(s) 61. Controller 61 stores, at storage unit 15, information linking image data and user-identifying information and information related to image processing apparatus(es) 10A (host name(s), IP address(es), time(s) at which unauthorized printing occurred, etc.) so as to make it possible for administrator(s) to carry out monitoring.

At network system 200 of FIG. 18, plurality of image processing apparatuses 10A are connected by network cable(s) 5, and respective image processing apparatuses 10A serve as copier(s) and/or printer(s). If information linking image data and user-identifying information were to be separately saved to each of the image processing apparatuses 10A, this would complicate administrative tasks in connection with unauthorized use; but in the present embodiment, because respective image processing apparatuses 10A merely send information linking image data and user-identifying information to monitoring server(s) 6, all of the information linking image data and user-identifying information and image-processing-apparatus-related information (host name(s), IP address(es), time(s) at which unauthorized printing occurred, etc.) to be saved being stored in batch fashion at storage unit(s) 15 of monitoring server(s) 6, administrative tasks need not be made complicated.

### Other Embodiments

Whereas the foregoing embodiments were described in terms of image processing apparatus(es) 10 (and/or 10A) serving as copier, printer, and/or scanner, the present invention is not limited hereto, it also being possible for same to serve as so-called PC fax machine(s) permitting facsimile transmissions to be sent from respective user terminal(s) 2. Furthermore, the present invention may also be applied to image processing apparatus(es) 10 (and/or 10A) provided with any one or more of these respective functions and to a network system equipped with such image processing apparatus(es) 10 (and/or 10A).

Moreover, whereas in the foregoing embodiments, it being assumed that IC card(s) or the like were subject to strict controls, usage was such that user ID identifying unit(s) 14a accepted entered user ID(s) or other such user-identifying information without further scrutiny, the present invention is not limited hereto, it also being possible, in anticipation of theft or other such unauthorized use of IC card(s), to provide user ID identifying unit(s) 14a with user authentication functionality or functionalities that checks for correspondence between user ID(s) and password(s) entered from user interface(s) 16 and allows only authenticated user(s) to utilize functionality or functionalities of image processing apparatus(es) 10 (and/or 10A). This will make it possible to more definitively match users with user IDs or other such user-identifying information. Furthermore, addition of user authentication functionality or functionalities may also be such that the network is provided with an authenticating server(s) (e.g., one(s) employing LDAP, i.e., Lightweight Directory Access Protocol or other such protocol, etc.), it also being possible to apply same where user ID numbers and passwords are managed in batch fashion by such authenticating server(s). Moreover, it is preferred not only that such authenticating server(s) manage user ID numbers and passwords, but that such authenticating server(s) also be provided with more sophisticated authentication algorithm(s) and/or that functionalities capable of being utilized be managed on a user-by-user basis.

Furthermore, whereas at the foregoing first embodiment, image processing apparatus(es) 10 was or were provided with user ID identifying unit(s) 14a, storage unit(s) 15, save determining unit(s) 14d, and algorithm execution unit(s) 14p, these being the constituent elements of the data monitoring apparatus therein, and whereas at the second embodiment, only storage unit(s) 15 among these constituent elements of the data monitoring apparatus was or were provided at monitoring server(s) 6, the present invention is not limited hereto, it being possible to arbitrarily choose which constituent element(s) should be provided at which component(s). For example, by providing shared server 4 with algorithm execution unit 14p, it is possible to achieve a constitution in which shared server 4 is itself able to carry out monitoring with regard to whether data intended for personal use is present. In such case, even where processing (printing processing or the like) of image data stored at shared server 4 is not performed, it would nonetheless be possible to find data involved in such unauthorized use. Furthermore, also within the purview of the technical idea of the present invention are configurations in which all of the constituent elements of the data monitoring apparatus are provided at shared server(s) 4, and configurations in which all of same are provided at monitoring server(s) 6.

The present invention may be embodied in a wide variety of forms other than those presented herein without departing from the spirit or essential characteristics thereof. The foregoing embodiments and working examples, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are, moreover, within the scope of the present invention.

1. In the context of one or more shared servers equipped with one or more shared data storage units storing shared data shared by a plurality of users, a data monitoring apparatus for monitoring data stored by at least one of the shared data storage unit or units, the data monitoring apparatus comprising:
one or more evaluating units
acquiring information pertaining to data stored by at least one of the shared data storage unit or units,
carrying out one or more shareability evaluations of such data based on at least a portion of the information, and
evaluating whether such data is involved in unauthorized use.

2. In the context of one or more network systems equipped with one or more shared servers storing shared image data shared by a plurality of users and equipped with one or more image processing apparatuses connected by network to at least one of the shared server or servers and performing image processing on image data acquired from at least one of the shared server or servers, a data monitoring apparatus for monitoring image data handled by at least one of the image processing apparatus or apparatuses, the data monitoring apparatus comprising:
one or more identifying units identifying one or more users requesting image processing;
one or more storage units capable of storing information linking at least one of the user or users identified by at least one of the identifying unit or units and at least a portion of image data involved with image processing requested by at least one of the identified user or users; and
one or more determining units determining whether to store information in at least one of the storage unit or units;
wherein at least one of the determining unit or units has
one or more evaluating units
acquiring, by accessing at least one of the shared server or servers, information pertaining to source data for image data handled by at least one of the image processing apparatus or apparatuses, and
evaluating whether at least a portion of the source data is involved in unauthorized use;
wherein, only in the event that it is determined based on at least one result of such evaluation that image data is involved in unauthorized use, is information linking at least a portion of such image data and at least one of the user or users requesting image processing of such image data caused to be stored by at least one of the storage unit or units.

3. A data monitoring apparatus according to claim 2 wherein at least one of the identifying unit or units, at least one of the storage unit or units, and at least one of the determining unit or units are provided at at least one of the image processing apparatus or apparatuses.

4. A network system wherein
at least one image processing apparatus or apparatuses equipped with at least one data monitoring apparatus according to claim 2 or 3 is connected by network to at least one of the shared server or servers; and
image processing of image data acquired from at least one of the shared server or servers is carried out by at least one of the image processing apparatus or apparatuses.

5. A data monitoring apparatus for monitoring image data within one or more shared servers storing shared image data shared by a plurality of users, the data monitoring apparatus comprising:
one or more evaluating units
acquiring information pertaining to image data subject to monitoring, and
evaluating whether such image data is involved in unauthorized use;
wherein, only in the event that it is determined based on at least one result of such evaluation that image data is involved in unauthorized use, is information to that effect sent.

6. A data monitoring apparatus according to claim 5 wherein at least one of the evaluating unit or units is provided at at least one of the shared server or servers.

7. A data monitoring apparatus according to claim 6 comprising:
one or more identifying units identifying one or more users requesting image processing;
one or more storage units capable of storing information linking at least one of the user or users identified by at least one of the identifying unit or units and at least a portion of image data involved with image processing requested by at least one of the identified user or users; and
one or more determining units determining whether to store information in at least one of the storage unit or units;
wherein at least one of the identifying unit or units, at least one of the storage unit or units, and at least one of the determining unit or units are provided at at least one image processing apparatus connected by network to at least one of the shared server or servers; and
only in the event that information to the effect that determination has been made that image data is involved in unauthorized use is received from at least one of the shared server or servers, does at least one of the determining unit or units cause information linking at least a portion of such image data and at least one of the user or users requesting image processing of such image data to be stored by at least one of the storage unit or units.

8. A network system wherein
at least one of the shared server or servers equipped with at least one of the evaluating unit or units of at least one data monitoring apparatus according to claim 5, 6, or 7 is connected by network to at least one of the image processing apparatus or apparatuses; and
image processing of image data acquired from at least one of the shared server or servers is carried out by at least one of the image processing apparatus or apparatuses.

9. In the context of one or more network systems in which one or more shared servers storing shared image data shared by a plurality of users, one or more image processing apparatuses performing image processing on image data acquired from at least one of the shared server or servers, and one or more monitoring servers are connected by network, a data monitoring apparatus for monitoring image data handled by at least one of the image processing apparatus or apparatuses, the data monitoring apparatus comprising:
one or more identifying units identifying one or more users requesting image processing;
one or more storage units provided at at least one of the monitoring server or servers and capable of storing information linking at least one of the user or users identified by at least one of the identifying unit or units and at least a portion of image data involved with image processing requested by at least one of the identified user or users; and
one or more determining units determining whether to store information in at least one of the storage unit or units;
wherein at least one of the determining unit or units has
one or more evaluating units
acquiring, by accessing at least one of the shared server or servers, information pertaining to source data for image data handled by at least one of the image processing apparatus or apparatuses, and
evaluating whether at least a portion of the source data is involved in unauthorized use;
wherein, only in the event that it is determined based on at least one result of such evaluation that image data is involved in unauthorized use, is information linking at least a portion of such image data and at least one of the user or users requesting image processing of such image data caused to be stored by at least one of the storage unit or units.

10. A network system wherein
at least one of the monitoring server or servers equipped with at least one of the storage unit or units of at least one data monitoring apparatus according to claim 9 is connected by network to at least one of the shared server or servers and to at least one of the image processing apparatus or apparatuses; and
image processing of image data acquired from at least one of the shared server or servers is carried out by at least one of the image processing apparatus or apparatuses.

11. A data monitoring apparatus according to any one of claims 2, 3, 7, and 9 wherein at least one of the identifying unit or units identifies at least one ID number of at least one of the user or users requesting image processing.

12. A data monitoring apparatus according to any one of claims 1 through 3, 5 through 7, and 9 wherein at least one of the evaluating unit or units
compares one or more numbers of user or users capable of accessing data subject to evaluation and one or more previously established default numbers of share or shares; and
in the event that at least one of the number or numbers of user or users capable of access is less than at least one of the default number or numbers of share or shares, causes such data to be evaluated as being involved in unauthorized use.

13. A data monitoring apparatus according to any one of claims 1 through 3, 5 through 7, and 9 wherein, in the event that one or more files containing data subject to evaluation has or have no file extension, at least one of the evaluating unit or units causes such data to be evaluated as being involved in unauthorized use.

14. A data monitoring apparatus according to any one of claims 1 through 3, 5 through 7, and 9 wherein, in the event that at least one file extension of at least one file containing data subject to evaluation does not correspond to one or more established file formats previously assigned to each respective variety of file extension, at least one of the evaluating unit or units causes such data to be evaluated as being involved in unauthorized use.

15. A data monitoring apparatus according to any one of claims 1 through 3, 5 through 7, and 9 further comprising:
one or more actual format detecting units detecting one or more actual file formats of data subject to evaluation;
wherein at least one of the evaluating unit or units
receives one or more output signals from at least one of the actual format detecting unit or units, and
in the event that at least one file format assigned to at least one file extension of at least one file containing data subject to evaluation does not match at least one of the actual file format, causes such data to be evaluated as being involved in unauthorized use.

16. A data monitoring apparatus according to any one of claims 1 through 3, 5 through 7, and 9 wherein at least one of the evaluating unit or units
compares one or more file attributes of data subject to evaluation and one or more default file attributes previously established for such data; and
in the event that at least one of the file attribute or attributes of data subject to evaluation does not match at least one of the default file attribute or attributes, causes such data to be evaluated as being involved in unauthorized use.

17. A data monitoring apparatus according to any one of claims 1 through 3, 5 through 7, and 9 wherein, in the event that data subject to evaluation is no longer present on at least one of the shared server or servers, at least one of the evaluating unit or units causes such data to be evaluated as being involved in unauthorized use.

18. A data monitoring apparatus according to any one of claims 1 through 3, 5 through 7, and 9 wherein a plurality of evaluative operations are employed in combination by at least one of the evaluating unit or units on data subject to evaluation so as to evaluate whether such data is involved in unauthorized use.

19. A data monitoring method capable of being carried out by one or more data monitoring apparatuses according to any one of claims 1 through 3, 5 through 7, and 9, the data monitoring method comprising:
one or more information acquiring steps in which information pertaining to data stored by at least one of the shared data storage unit or units of at least one of the shared server or servers is acquired; and
one or more evaluative steps in which
one or more shareability evaluations of such data is or are carried out based on at least a portion of the information acquired at at least one of the information acquiring step or steps, and
evaluation is made with respect to whether such data is involved in unauthorized use.

20. A computer program for causing one or more computers to carry out one or more data monitoring methods according to claim 19.
